(19) United States
(12) Patent Application Publication
(10) Pub. No.: US 2022/0168960 A1
(43) Pub. Date: Jun. 2, 2022

(54) METHOD OF 3D PRINTING SHAPES DEFINED BY SURFACE EQUATIONS

(71) Applicant: Matthew Stefan Muller, Bloomington, IN (US)

(72) Inventor: Matthew Stefan Muller, Bloomington, IN (US)

(21) Appl. No.: 17/602,374

(22) PCT Filed: Apr. 10, 2020
(86) PCT No.: PCT/US2020/027685

§ 371 Date: Oct. 8, 2021

Related U.S. Application Data
(60) Provisional application No. 62/832,253, filed on Apr. 10, 2019.
(60) Provisional application No. 62/968,955, filed on Jan. 31, 2020.

(51) Int. Cl. B29C 64/386; B29C 64/135; B29C 64/188; B29C 69/02; B33Y 10/00; B33Y 40/20; B33Y 50/00

(52) U.S. Cl. CPC B29C 64/386; B29C 64/135; B29C 64/188; B29C 45/14; B33Y 10/00; B33Y 40/20; B33Y 50/00; B29C 69/02

(57) ABSTRACT

A method of 3D printing a part using a photopolymer build material including the steps of characterizing a three-dimensional curved surface using a mathematical equation and a specification; characterizing at least one surface transition between at least two parallel slice planes that intersect the characterized three-dimensional curved surface using a surface transition equation; generating at least one set of 3D printing instructions to selectively solidify the photopolymer build material; and 3D printing the part using the at least one set of 3D printing instructions.

### CROSS-REFERENCE TO RELATED APPLICATIONS

This application is related and claims priority to U.S. Provisional Patent Application Ser. No. 62/832,253 filed on Apr. 10, 2019 and U.S. Provisional Patent Application Ser. No. 62/968,955 filed on Jan. 31, 2020. The complete and entire disclosures of each of these applications are hereby expressly incorporated by reference herein.

### BACKGROUND OF THE DISCLOSURE

This invention relates to a method of 3D printing in which a three-dimensional (3D) part is created by solidifying photopolymer material with a scanned laser source or a spatial light modulator. The class of 3D printers associated with this type of 3D printing is commonly referred to as stereolithography (SLA) when using a scanned laser source and mask-image-projection stereolithography (MIP-SL) when using a spatial light modulator. A common feature of these classes of 3D printers is that parts are produced gradually, either stepwise or continuously, from a two-dimensional (2D) build plane. Over time, material is added to the part being built based on the cross-sectional part geometry at the build plane.

The traditional method of 3D printing a part from a series of 2D build planes requires several steps. The part is first designed using computer aided design (CAD) software. When the part design is complete, tessellation is performed to characterize the part surface in three dimensions. Tessellation is usually performed using many interconnected triangular shapes that together create a mesh of the surface. The tessellation vertices that characterize the 3D part surface are exported to a file, and sometimes also include associated normal vectors, colors for part features, and other part characteristics. A number of file formats exist for storing tessellated part data; some examples are the STL (Standard Triangle Language), OBJ, PLY, and 3MF file formats. The tessellated data set is then imported into a 3D slicing software package and processed into a series of cross-sectional “3D slices” that are comprised of mask images or scanning path instructions that are provided to the 3D printer. The 3D printer then gradually builds the three-dimensional part by adding or solidifying material in a layer by layer fashion using the corresponding slicing data. A build stage is translated so that the thin solidified layers are overlaid and bounded together to create a 3D part. This general method of 3D printing parts has been applied since the earliest development of 3D printing technology in the 1980's and, apart from niche 3D printing research applications, is the standard approach widely used for 3D printing with commercially available 3D printers today.

The popular use of tessellation is due in part to its capability to adequately characterize most part geometries in the millimeter to tens of centimeter range without extensive intervention by the designer. It is well-known that tessellation approximates the true part surface, and some commercially-available CAD software packages permit setting a maximum chord height and angular deviation to allow a designer to trade off accuracy with the number of tessellation vertices and resulting file size required to characterize a part. Current computing capabilities can provide tessellated surfaces with tolerances that are below the print resolution of many tabletop 3D printers, which is typically 30-300 micrometers.

CAD part modeling predominantly uses boundary representation (B-rep) to characterize 3D part features. Function representation (F-rep) is another method of modeling parts, which applies boolean operations to functions and implicit equations of surfaces. An advantage of F-rep is that it provides an accurate and simple method of performing blending, distorting, and intersecting operations on part features that are described by equations. F-rep can be used to describe a set of primitive shapes that are combined using a binary tree to describe a more complex 3D object, a process that is commonly referred to as constructive solid geometry (CSG).

In its limited use in 3D printing, F-rep models are usually tessellated and sliced using traditional methods. Researchers have also proposed direct slicing, in which the tessellation step is skipped. In direct slicing, a cross sectional contour of an F-rep part is generated by sampling in the slicing plane. In this case, the cross-sectional contours are sampled in two-dimensions, effectively rasterizing each layer using a 2D coordinate array, and discarding the functional representation of the part. By defining the desired solidification region on the rasterized slicing plane, 3D printing instructions to solidify a layer of a 3D printed part can be generated using traditional techniques. This process has been demonstrated for generating G-code instructions for the path of an extruder head used in a fused deposition modeling (FDM) 3D printer. The stated advantages of direct slicing over tessellation are that the extracted 2D sampled contours are function-faithful, providing improved accuracy of the cross section, and avoid tessellation errors associated with complex inner part structures, missing geometry, redundant triangles, etc. Although F-rep models can be expressed in shorter forms than tessellated B-rep equivalents, this is largely dependent on the geometry of the part.

3D slicing software is commonly considered as a type of computer-aided manufacturing (CAM) software that enables the manufacturing of parts using a 3D printer. Numerous open source and commercial 3D slicing software packages exist, and methods for generating 3D printing instructions and toolpaths for adding or solidifying material in a given layer are well-documented. 3D slicing software frequently performs additional tasks, such as STL file analysis and repair, part positioning and orientation, adding raft and support structures to ensure proper part fabrication, and replacing solid bodies with an internal honeycomb structure to reduce material use and weight while maintaining structural strength. 3D slicing software can be stand-alone, i.e. operable on a computer that is separate from the 3D printer, or incorporated into the 3D printer.

The 3D printing instructions for a given slicing plane are provided either directly by a PC, or according to a specified communication protocol to a microcontroller, mini-PC, field programmable gate array (FPGA) board, or other similar electronic hardware controller used by a 3D printer. The hardware controller interprets the instructions and applies them by adjusting the operation of various hardware components as-needed to solidify material according to the part design. The typical hardware components that are controlled by an SLA or MIP-SL 3D printer may include an illumination source such as a laser, a fiber laser, a light emitting diode (LED) or lamp, a spatial light modulator such as a liquid crystal display or a digital light projector, an LED array, an XY scanning or other beam displacing component, an XY translation component, a laser polarization or intensity modulator, a build stage motor, a part peeling mechanism, and a photopolymer material wiper blade.

SLA 3D printers typically feature an ultraviolet (UV) or near-UV actinic laser beam that is rapidly scanned across the 2D build plane using a 2D beam scanner, beam deflector, or beam displacing component. Alternatively, an SLA 3D printer can operate by translating a UV or near-UV actinic laser and focusing optical module over a 2D plane, similar to an extrusion head on a fused deposition modeling printer. In either case, the actinic laser light is focused to a spot at the 3D printer's build plane, where it initiates photopolymerization once the delivered exposure exceeds a material-specific curing threshold value. A hardware controller is used to control the spatial location of the laser exposure at the build plane according to each 2D cross-sectional slice of the part being built. There are a number of well-known methods to scan, deflect or displace a laser beam; some of the more common methods use: a galvanometer mirror, a rotating polygon mirror, a MEMS 1D or 2D mirror, a piezo-actuated mirror, and a pair of rotating optical wedges. The shape of the cumulative exposure and curing depth delivered by a one-dimensional scanned Gaussian laser has been modeled by integrating the Gaussian irradiance function along an infinite scan length. In this case, a fixed speed is used to determine the cumulative exposure line spread function, which is a Gaussian in a plane normal to the scan direction. The cumulative exposure is constant along the scan direction.

Since the laser spot in an SLA printer needs to solidify material over the part's cross-section for each layer, a frequently cited drawback of laser scanning-based 3D printers is the time required to build a part. With a powerful enough focused laser source and sufficiently photo-sensitive photopolymer resin, solidification can occur very rapidly. The time required to print each layer is therefore typically limited due to the maximum speed of the scanning elements, which is typically in the 100 Hz to several kHz range for a pair of non-resonant XY galvanometer scanning mirrors. Resonant scanning mirrors are considerably faster, in the 10 kHz range but must be driven at a fixed sinusoidal frequency, which generally forces a raster scanning build strategy when a more complex scan path geometry may be suitable for building a variety of parts.

MIP-SL 3D printers typically use a UV or near-UV lamp, laser, or LED actinic illumination source in combination with a spatial light modulator to illuminate the build plane with a 2D mask image. Spatial light modulators typically feature a 2D array of controllable and addressable elements; well-known examples include: a liquid crystal display (LCD), a liquid crystal on silicon chip (LCoS), and a digital micromirror device (DMD). An illumination source combined with relaying and focusing optics and a DMD is commonly called a digital light projector (DLP). A MIP-SL printer can alternatively use an addressable array of light sources, such as an LED array, for mask illumination. The plane of the spatial light modulator or LED array is refocused to a conjugate build plane, where it initiates photopolymerization once the delivered exposure exceeds a material-specific curing threshold value. In MIP-SL 3D printers, a spatial light modulator or LED array driver is used as the hardware controller and sets the 2D array of addressable elements according to a mask image of the cross-sectional area to solidify.

Projection microstereolithography (PμSL) 3D printers are a type of MIP-SL 3D printers that are designed for building smaller (micrometer to millimeter) part features. Due to the finite number of spatial light modulator array elements, a higher lateral resolution in PμSL results in a smaller build area. Since the primary difference between PμSL and MIP-SL is the optical magnification between the build plane and the spatial light modulator, both PμSL and MIP-SL 3D printers are referred to herein as MIP-SL.

Most SLA and MIP-SL 3D printers progressively solidify a set of discrete 2D layers, each with a fixed or variable layer thickness. After a 2D layer is cured to a specified layer thickness, the build plate is translated in an orthogonal direction to the build plane, and a fresh coat of liquid photopolymer resin is reapplied to the build plane, usually with a wiper to ensure photopolymer uniformity, so that a 3D part can be gradually built from a sequence of solidified 2D layers.

Commercially available SLA and MIP-SL 3D printers achieve layer heights ranging from approximately 10 to 400 microns. The impact of layer height on part quality is readily observed as a staircase artifact on surfaces that are sloped relative to the build plane. The staircase artifact is due to the approximation of the 3D surface by a series of stacked two-dimensional planes (layers) that are separated by the layer height.

Continuous layer 3D printers exploit photopolymerization kinetics and curing rates to perform carefully timed photopolymerization in synchrony with a slow, non-stop motion of the build stage. One such continuous layer process is called continuous liquid interface production (CLIP), which uses a semi-permeable window to locally inhibit polymerization. While requiring careful design of the build stage speed, these printers operate using 3D printing instructions generated from the same standard part tessellation and slicing methods as discrete layer 3D printers. These printers can use either the SLA or MIP-SL illumination process to solidify the photopolymer build material and are therefore considered herein to be a subset of SLA or MIP-SL 3D printers, respectively. The advantage most commonly attributed to continuous layer 3D printers is a faster build speed and the reduction of staircase artifacts.

Once 3D printing is completed, parts are typically washed to remove uncured photopolymer resin, and then post-cured and/or baked at elevated temperatures to improve material properties such as yield strength, Young's modulus, and heat deflection temperature. Post-processing, by sanding, melting, spin coating, or otherwise applying a film to the part surface is frequently performed to eliminate surface defects and achieve a desired aesthetic or functionally smooth surface.

The photopolymer resins used by SLA and MIP-SL 3D printers are typically characterized by their optical absorption spectra and curing behavior, which is commonly modeled empirically by the Beer-Lambert law. Under this model, incident actinic light is exponentially absorbed according to the photopolymer resin's characteristic penetration depth and critical exposure. Together, these photopolymer resin-specific parameters provide a linear semi-log fit of the cure depth vs. cumulative laser exposure within normal operating ranges, shown below in Equation 1 and commonly called the working curve.

$${C}_{d} = {D}_{p} ln ( \frac{E}{{E}_{c}} ) \qquad ( 1 )$$

where C_{d} is the curing depth, Dₚ is the characteristic penetration depth of the photopolymer resin, E is the delivered exposure and E_{c} is the critical exposure necessary for the resin to start to solidify (i.e. the gel point of the resin). As shown by Equation 1, the slope of the working curve is equal to the characteristic penetration depth, and the x-intercept is the critical exposure, which is the exposure that yields a zero curing depth.

Photopolymer resins are frequently developed and engineered to achieve desired optical, polymerization, and mechanical properties. For example, a photopolymer may include a dye that absorbs light at the illumination wavelength to decrease the achievable penetration depth and limit unwanted over-curing. The amount of photoinitiator added to a photopolymer resin can be adjusted to similar effect. Photopolymer resins may also include a wax, ceramic, silica, or metallic powder precipitate, nanoparticles, or other filler material. In this case, the 3D printed part may be baked to burn out or liquify the solidified resin and sintered to achieve final material properties similar to the filler being used. Fillers may also be used to improve the geometric accuracy of the final part by, for example, reducing shrinkage and distortion. In each of the above cases, it is well-known that changes to the composition of the photopolymer resin will result in changes to the characteristic working curve. Researchers have added terms and coefficients to Equation 1 to improve its accuracy by accounting for factors such as: dye concentration, polymerization kinetics, nonlinear optical behavior and optical scattering.

A photopolymer material can be calibrated using an SLA printer with a series of closely-spaced raster scans of a Gaussian laser that is focused at the build plane. When the spacing between scans, also called the hatch spacing, is less than the Gaussian 1/e² half-width of the focused laser beam, the cumulative exposure takes on an increasingly planar profile as the hatch spacing decreases. A series of closely-spaced raster scans that are generated with approximately constant laser power and transverse scanning speed produce an approximately planar exposure dose at the surface of the photopolymer material. A planar exposure dose will produce a planar solidified surface, with a curing depth determined by Equation 1. Those skilled in the art will readily recognize and appreciate that a scanned Gaussian laser beam was selected for the derivation of a linear and planar cumulative exposure at the surface of the photopolymer material due to: the widely studied and understood field of Gaussian optics; the availability of laser sources with Gaussian, or near-Gaussian, output beams; and the ability to arrive at an analytical solution from which the effects of variables can be more easily understood. Those skilled in the art will appreciate that a non-Gaussian laser beam can be used to achieve a planar cumulative exposure dose, and that the cumulative exposure can be calculated numerically using laser irradiance functions that incorporate multi-mode and non-circularly symmetric behavior. Those skilled in the art will appreciate that a cumulative exposure function can be computed with an irradiance function that varies spatially, such as when the angle of incidence between the optical axis of the laser beam and the surface normal of the photopolymer material varies along a scan line.

The WINDOWPANE™ method is one well-known photopolymer calibration technique in which a series of single-layer supported rectangular areas, or windowpanes, are cured with an approximately planar exposure dose. By varying the scanning speed, the cumulative exposure dose and associated curing depth can be varied. To avoid scanning acceleration and deceleration effects, the curing depth is typically measured in the center of the windowpanes, where the scanning speed is approximately constant and the cumulative exposure dose is approximately planar. It is well-appreciated by those skilled in the art that a similar calibration method could be performed by varying the laser power instead of the scanning speed, that the windowpanes could be cured directly on a coverslip or other transparent surface, and that the curing depth can be measured mechanically using a micrometer or stylus profilometer, or optically using an interferometer, ellipsometer, or similar depth measuring apparatus. Curing material directly on a coverslip or other transparent material can help to avoid the risk of damaging the thinly cured layer. Typically, curing depths in the range of 1-4 times the characteristic penetration depth are used to create the working curve, with some initial trial and error required to find the appropriate range of cumulative exposure doses. Gentle part washing is usually performed to remove liquid resin from the solidified layer and ensure an accurate measurement of the curing depth.

A photopolymer material may also be calibrated using a MIP-SL illumination module. In this case, the uniformity of the projected illumination field is measured and calibrated. The pixel values assigned to the mask image are typically set to the grayscale values necessary to provide a uniform projected illumination. Several regions of a photopolymer material are exposed to mask images with a known exposure duration. The exposure duration may be set on the illumination source directly, by the duration of the display of the mask image, or with the use of calibrated grayscale pixel values. The depth of the solidified photopolymer material is measured in the center of each solidified region, where the exposure is approximately planar. In an alternative approach, one mask image is used for curing several trays that contain photopolymer resin with varied exposure times or calibrated grayscale pixel values.

The curing process depends on the spatial-temporal behavior of the actinic illumination source at the 3D printing build plane. For SLA 3D printers, the irradiance of the illumination source measured at the build plane, the laser scanning speed, and laser scanning path all contribute to the curing geometry. For MIP-SL 3D printers, the irradiance of the illumination source measured at the build plane resulting from one or more spatial light modulator grayscale mask patterns, and the duration of the exposure, contribute to the curing geometry.

A variety of photopolymer calibration techniques and curing geometry results have been published in the scientific literature.

Print quality with either MIP-SL or SLA 3D printers can suffer from under-curing or over-curing layers. When a layer is insufficiently cured, liquid or gel-like material may be undesirably removed from what should be a solid feature and adjacent layers may not sufficiently bond together, compromising the structural integrity, geometric accuracy, and aesthetic of the final part. Conversely, over-curing occurs when photopolymerization is initiated beyond the desired layer height. This effect, also called print-through or z-bleed, can further modify the shape of a previously cured layer, which also affects the geometric accuracy and aesthetic of the final part. In general, photopolymer-based 3D printers are calibrated using the working curve to cure uniform layers at a prescribed layer thickness. The impact of building a 3D part from stacked 2D layers with a layer thickness that's typically between 10 and 400 micrometers is readily observed in the form of staircase artifacts on surfaces that are sloped relative to the build plane. Staircase artifacts are a well-known problem in 3D printing that can affect the functional and aesthetic properties of the desired 3D printed part.

Efforts have been made to reduce the achievable layer height so that staircase artifacts are minimized to the point of being aesthetically or functionally acceptable without requiring further post-processing. Since a smaller layer height implies a greater number of layers required for building a fixed size object, the printing time increases as the layer height is reduced. The disadvantage of a longer print time may outweigh the benefit of using small layer heights, depending on the application of the 3D printed parts. Different 3D printing technology and architectures have varied layer heights and the ability to modify or reduce the layer height. Some approaches used to remove the staircase artifact during printing include the development and use of continuous layer 3D printers, the use of gradient, or grayscale, illumination masks, and the curing of a photopolymer meniscus formed at the boundaries of the layers. Although it is straight-forward to mechanically adjust the layer height used by a 3D printer, the photopolymer resin's characteristic penetration depth needs to be considered. As the penetration depth exceeds the layer height, the exposure must be carefully managed to avoid unwanted overcuring into adjacent layers.

It is well-known that the surface quality achieved using SLA and MIP-SL 3D printers is dependent on the 3D printer architecture and the respective orientation of the part being built. In some cases, slight over-curing has been shown to help smooth previously cured layers. Since photopolymerization is initiated from the first resin surface that actinic illumination reaches and is approximately absorbed according to the Beer Lambert law, partial layer curing can only help to provide smoother transitions between layers for specific curve orientations.

3D printers typically build a part by selectively solidifying photopolymer material to the full layer thickness for each layer. At least some full layer curing is required when building a part so that adjacent layers can adhere to one another. Partial layer curing has been performed using process planning, in which the cumulative exposure dose is tuned to achieve a smoother or more accurate part profile, either in the lateral (XY) or depth (Z) direction. Process planning is performed by modelling the SLA or MIP-SL irradiance and simulating an exposure dose to deliver and the resulting part geometry. The simulated exposure dose is iteratively adjusted, typically by varying the XY scanner speed in SLA and grayscale DLP pixel values in MIP-SL, to reduce the error between the simulated resulting part geometry and the actual part design. The numerical method of determining variable scanner speeds and grayscale DLP pixel values operates using sliced tessellated part files and does not consider any functional representation of the cross section of the part. Despite the reported resolution benefits of process planning, it is not generally used in 3D printing, primarily due to the relatively small perceived benefits in relation to its high computational complexity and time requirements, as well as the effort required to measure and simulate curing performance across the illumination field of view.

Particular embodiments of the present invention specifically relate to the use of a 3D printer to fabricate an optically smooth surface that is suitable for the production of optical components such as lenses and mirrors. As used herein, the term optical components refers to objects that include at least one optically smooth surface. An optically smooth surface is considered herein to refer to a surface with a mean roughness of less than one fifth the wavelength of light that is specified for use with the optical component. Such objects may be 3D printed and, for example, used directly as optical components (e.g. lenses). Optical components can also be fabricated by 3D printing a part that is subsequently coated to achieve an optically smooth surface (e.g. lenses and mirrors). Alternatively, optical components can be fabricated by 3D printing molds with an optically smooth surface achieved directly from the printing process, or in post-processing. A two-part 3D printed mold may be mounted to machined metallic parts (e.g. platens) that are pressed together to create optical components from a desired melted glass, plastic, or other optically transparent material. For 3D printed molds, at least one 3D printed part has an optically smooth surface, and is used to fabricate an optical component via a molding process.

As described herein, a part or surface height or sag is defined on an axis that is orthogonal to a build plate and a build plane used by a 3D printer. A photopolymer material depth is defined on the same axis as the surface height. In general, the term height is used to describe a surface or part geometry, while depth is used when describing the photopolymerization process, partial layer curing, and the shape or profile of a solidified layer.

Due to the capabilities of turning, milling and polishing machines used in traditional optical manufacturing, circularly symmetric lenses and mirrors have long been the easiest to produce and are widely used in optical systems today. Their surfaces can be described using a conic surface sag equation that is expressed explicitly in cylindrical coordinates:

$$z ( r ) = \frac{c {r}^{2}}{1 + \sqrt{1 - ( 1 + k ) {c}^{2} {r}^{2}}} \qquad ( 2 )$$

where z(r) is the radially-dependent sag, or depth, of the surface, c is the curvature (reciprocal of the radius of curvature), r is the radial coordinate, and k is the conic constant.

By convention, the surface sag described by Equation 2 includes one of two possible solutions for z found from the implicit equation of a quadric surface:

$${r}^{2} - \frac{2 z}{c} + ( 1 + k ) {z}^{2} = 0 \qquad ( 3 )$$

Equation 3 can also be rearranged to a single-sided explicit function of the radius, r, with respect to the depth z:

$$r ( z ) = \sqrt{\frac{2}{c} z - ( 1 + k ) {z}^{2}} \qquad ( 4 )$$

As optical manufacturing capabilities have improved, new classes of optics, such as aspherical and freeform optics have emerged. Aspherical components are of interest since they can be designed to reduce spherical aberrations that are otherwise present with spherical optics. Freeform optics usually lack lateral and/or angular symmetry and are of interest for their potential ability to reduce the size, weight and cost, or improve the performance of optical systems made with traditional (spherical) components. As with other optical components, the surface of aspherical and freeform optical components, such as for example mirrors, windows or lenses, are described and modeled in optical design software using mathematical equations, typically polynomials.

While less common, optical surfaces can be described using other mathematical equations and techniques that are described in commercial optical ray tracing software packages. For example, aspheric surfaces are often described by adding additional polynomial terms to Equation 2, or as a superconic surface. Some other methods commonly used to characterize optical surfaces include: Chebyshev polynomials, Zernike polynomials, polynomials in cartesian coordinates, biconic surfaces, modulated surfaces, toroidal surfaces, cubic splines, NURBS curves. While optical surfaces are frequently circularly symmetric, there is no requirement for circular symmetry. Some optical components, such as lens arrays, can be piece-wise modeled by joining multiple lens surfaces together, with each surface being defined over a specified interval. Freeform optics, which generally lack symmetry, are still commonly defined using either a mathematical equation or a piece-wise defined mathematical equation.

Traditional optical component fabrication frequently requires several stages of inspection and correction to obtain an optical surface quality with the desired shape geometry. This fabrication process requires a high capital investment and significant time to produce custom optical components to specification, and thus methods to 3D print optical components or molds for optical components at lower cost and on faster time scales would be appreciated.

In high-volume applications, optical components are commonly molded from polymers and glass. Well-established molding techniques are used for molding optics, some of which include: injection molding, compression molding injection-compression molding, glass molding, precision glass molding, overmolding, casting, glass replication, and wafer-level glass replication. In the case of molded optical components, the temperature and pressure used in the molding process can affect the optical properties of the final part. The affected optical properties may include: refractive index, dispersion, birefringence, and optical transmission across a desired wavelength range. Additive manufacturing methods that reduce the time, cost, and capital investment required to fabricate custom optical components would be appreciated, and have been the subject of ongoing research.

A well-known application of 3D printers is the production of soft tooling. While soft tooling does not usually permit a high number of molding cycles, it has been recognized as a means to rapidly produce and prototype small quantities of custom parts at low cost. 3D printers have been used to build parts that are used as molds and mold inserts for rapid prototyping purposes. Lost-wax casting is a particularly well-known application for making jewelry using a photopolymer material with a wax filler or with wax-like properties to achieve a clean burn-out.

Typically, the strength and heat deflection temperature of 3D printed polymer materials are considerably lower than that of metals, making 3D printed soft tooling unsuitable for high volume production runs with hundreds to thousands of cycles. However, small volume applications with up to tens of cycles have been shown to be viable for a range of 3D printed parts at relatively low mold temperatures. One issue that arises when using 3D printed polymer molds is that polymers are poorer heat conductors, and require longer cooling times prior to ejection. This undesirably increases the cycle time, which can potentially be resolved by: using a metallic polymer filler, ejecting the part as soon as possible to avoid heat build-up in the mold, and back-filling the 3D printed mold with a metal or other heat conducting material to help increase the mold cooling rate. Frequently, the mold is held at a desired elevated temperature to help reduce shrinkage and other stresses that affect the structural integrity and geometric accuracy of the final molded part.

Optical components are different from many other types of parts traditionally built with 3D printers in that they require an optically smooth surface over a macroscopic scale. 3D printed optical components and 3D printed molds for molding optical components have been reported by researchers in the scientific literature. Reported approaches include: SLA and MIP-SL photopolymerization, multi-photon photopolymerization, selective direct-ink writing, electrospinning, and polyjet printing. The production of various micro-optical components, small lenses, and/or fibers have been reported by research groups. In at least the cases of multi-photon photopolymerization and polyjet printing, the 3D printing apparatus and approach require investments of time and cost similar to traditional optical manufacturing. A method of fabricating optical components or molds for optical components using more cost-effective and faster 3D printing technology would therefore be appreciated.

Using more cost-effective discrete-layer SLA or MIP-SL 3D printing techniques to achieve an optically smooth surface requires the removal of staircase artifacts. Researchers have worked to mitigate staircase artifacts in a variety of ways, including the use of gradient or grayscale illumination masks, meniscus curing, melting the exterior surface, applying coatings to the exterior surface, or polishing the exterior surface after 3D printing is completed. Typically, the grayscale pixel values are computed based on the difference between adjacent sliced mask images, which are a pixel-approximation of the true cross-sectional contour boundary. The use of meniscus curing, coatings, and polishing all add time and material to the overall building process. These techniques also require additional part handling, and risk altering the part geometry in unpredictable ways that reduce manufacturing tolerances and yields when compared to traditional alternatives. A method of fabricating optical components or molds for optical components using cost-effective and fast 3D printing technology that can minimize staircase artifacts with a greater control of the solidification process would therefore be appreciated.

Continuous layer printers have been shown to reduce staircase artifacts by reducing the photopolymer's characteristic penetration depth and slicing a model with a very narrow slice thickness. Gradient illumination with meniscus curing has been demonstrated using a custom-built continuous layer 3D printer. In this case, the stated motivation for using a continuous layer printer was to reduce the build time, and surface roughness was not improved over a previously reported discrete-layer 3D printing process using gradient illumination and meniscus curing.

The use of an illumination mask in MIP-SL 3D printers is well-known to decrease the time required to build a part. However, a spatial light modulator that features a rectilinear pixel array introduces new challenges when used to cure round, often circular, layers of an optical component. With micrometer-sized pixels, aliasing, a fill factor less than 100%, and interpolation along the curved three-dimensional sections of an optical component results in a sub-optimal surface roughness at micrometer and nanometer scales, even when a continuous layer MIP-SL 3D printer is used. These issues may be partially remedied with computationally complex pixel blending or pixel shifting approaches, though they have to-date been configured to improve either lateral or depth resolution, which is insufficient for curing a three-dimensional curved surface. For a MIP-SL printer to approach the surface smoothness performance that could be attained with SLA, an ever-increasing number of pixel shift positions and number of exposures per layer is required, removing much of its speed advantage.

Regardless of the specific type of 3D printing, 3D printed optical components have been to-date designed in CAD software, tessellated, and 3D sliced before they are built. The tessellated dataset represents a three-dimensional approximation to the part geometry, sometimes called a mesh surface. Areas between vertices are usually linearly interpolated, which produce inaccuracies on curved surfaces, commonly characterized by a maximum chord height. To achieve a higher tessellated resolution, a larger number of vertices is required, resulting in a larger tessellated part file and longer processing times. 3D slicing at a higher slice resolution likewise requires more processing power and time to complete. Since tessellation is performed automatically, and the vertices for a mesh surface are typically not known in advance, numerical, iterative search, methods are required for process planning. These methods also become more complex and require greater computation time and power, as the size of the tessellated dataset increases. A method of 3D printing that therefore reduces process planning time, file size, data transfer time, while improving 3D printed surface accuracy and smoothness would be appreciated.

The present invention is intended to improve upon and resolve some of these known deficiencies within the relevant art and is directed toward the purpose of 3D printing parts that feature smooth surfaces.

### SUMMARY OF THE INVENTION

This invention relates to efficiently and accurately 3D printing a part using a photopolymer-based 3D printer. In accordance with certain aspects herein, the 3D printed part features a three-dimensional curved surface that is characterized by a mathematical equation and a specification. According to this exemplary aspect, the overall part geometry can be characterized using mathematical equations, or more traditionally using a tessellated part file. The curved surface, in accordance with this embodiment, is a continuous or piece-wise continuous curved surface, such as a three-dimensional surface or as a two-dimensional plane curve that is used to define a three-dimensional surface. The specification provides details about the curved surface, for example surface-specific parameters, coefficients to use in the mathematical equation, or an interval over which the curved surface is defined.

In accordance with certain aspects herein, 3D slicing of the three-dimensional curved surface is mathematically performed at high resolutions using well-known algebraic and numeric techniques, without the need for a tessellated part file. According to these illustrative aspects, a surface transition equation that describes the region of the curved surface that is bounded between at least two parallel slice planes is determined using well-known algebraic and numeric techniques. The actinic exposure to deliver to the photopolymer resin is then computed based on the desired solidification region between the curved surface and the part, the surface transition equation, and the photopolymer curing behavior. At least one set of 3D printing instructions are generated to achieve the required spatial-temporal actinic exposure to solidify a surface profile that approximates the surface transition equation. The 3D printing instructions are interpreted by the 3D printer to control its operation and build the part that features the curved surface.

In accordance with certain aspects herein, the methods of the present disclosure are able to generate improved 3D printed accuracy and surface smoothness. Moreover, the methods in accordance with the present disclosure further offer improved processing speeds, the elimination of unnecessary CAD design work, and improved specified surface accuracy than can be achieved using tessellation.

According to certain aspects herein, the presently disclosed methods offer analogies to the use of vector instead of rasterized graphics. Similar to vector graphics, a set of coefficients for a known surface equation can be used to calculate the precise location of the surface over a range of resolutions without data loss. In contrast, rasterized graphics (and tessellation) are computed at a defined resolution and size; scaling the resolution or size requires data interpolation to approximate the location of the surface. An advantage of performing process planning using a surface represented by a mathematical equation is that it enables a more accurate and faster method of computing the actinic illumination exposure than currently provided by existing techniques.

When applied specifically to optical manufacturing, the illustrative methods of the present invention can be used to efficiently and accurately 3D print parts that feature optically smooth surfaces characterized by mathematical equations used by optical designers and engineers. These parts can be subsequently coated to produce a mirror. When 3D printing is performed with a transparent material, this method can be used to produce a lens, with or without an additional anti-reflection or protective coating. Finally, in accordance with certain illustrative aspects, this method can be used to produce positive or negative molds of an optical component, with the final optical component being fabricated using well-known molding processes.

According to one aspect of the present disclosure, a method of 3D printing a part using a photopolymer build material is provided. In accordance with this aspect, the method comprises the steps of: (a) characterizing a three-dimensional curved surface using a mathematical equation and a specification; (b) characterizing at least one surface transition between at least two parallel slice planes that intersect said characterized three-dimensional curved surface using a surface transition equation; (c) generating at least one set of 3D printing instructions to selectively solidify said photopolymer build material; and (d) 3D printing said part using said at least one set of 3D printing instructions. In accordance with this illustrative aspect, the step of generating at least one set of 3D printing instructions to selectively solidify said photopolymer build material is accomplished by using (i) at least one solidification region defined on at least one slice plane that intersects said characterized three-dimensional curved surface; (ii) said surface transition equation; and (iii) a photopolymer-specific relationship between an actinic exposure and a photopolymer solidification thickness.

In accordance with certain aspects herein, a mathematical equation used to characterize a three-dimensional curved surface comprises using at least one of: an analytic equation that is continuous over a real domain of a three-dimensional curved surface; a piecewise-defined equation that comprises at least two analytic sub-functions and is piecewise continuous over a real domain of a three-dimensional curved surface; at least one plane curve that is continuous or a piecewise-continuous and describes said three-dimensional curved surface when extended into three-dimensional space; and a conic section.

In accordance with still other aspects of the present invention, a specification used to characterize a three-dimensional curved surface comprises using at least one of: a conic section eccentricity; a conic section focus; a conic section directrix; a conic section axis; a conic section vertex; a weighted control point; and a domain that defines a spatial extent of a plane curve in at least one dimension that extends to a spatial extent of said three-dimensional curved surface.

In accordance with yet other aspects of the present invention, a specification used to characterize a three-dimensional curved surface comprises using at least one of: a mathematical equation type, a mathematical equation form, and a generating function; a coefficient of at least one term in a mathematical equation; at least one term to evaluate a power series representation of a mathematical equation; an angle of rotation of said curved surface; a translation of said curved surface; a normal vector at a point on said curved surface; a domain that defines a spatial extent of said curved surface in at least one dimension of real three-dimensional space; a piecewise sub-function used to at least partially characterize said curved surface; an interval that defines a piecewise sub-function used to at least partially characterize said curved surface; and a computer aided design file or a point-cloud file that permits a characterization of said curved surface using a known or approximative mathematical equation.

According to further aspects herein, the step of using a specification further comprises using at least one boundary condition to define at least one solidification region, the at least one boundary condition comprising at least one of: a direction; a coordinate point; a vector; an axis; a boundary surface; and a boundary plane curve used to characterize a boundary surface.

In accordance with other aspects of the present invention, at least one mathematical equation and specification is transmitted electronically using at least one of: a software application; a plugin to a software application; a website; electronic mail; a web application; and a plugin to a web application.

In accordance with still other aspects herein, at least one of mathematical equation and at least one element of a specification is automatically reviewed by evaluating at least one of: a surface curvature that comprises a three-dimensional curved surface; a surface area that comprises said curved surface; a spatial extent of said curved surface in real three-dimensional space; a solidification region of a part volume that comprises said curved surface; a presence of a discontinuity within a domain of said curved surface; and a boundary condition of a part volume that comprises said curved surface. An automatic review permits the discovery and mitigation of potential issues associated with 3D printing, such as the ability to accurately build certain surface geometries, certain surface orientations, certain surface discontinuities, and overall surface and part sizes.

According to still further aspects herein, at least one of mathematical equation and specification is automatically processed to provide at least one of: a price estimate for 3D printing a part comprising a specified three-dimensional curved surface; a price estimate for producing a molded part from at least one 3D printed part mold that comprises said specified three-dimensional curved surface; a manufacturing time estimate; a visualization of said specified three-dimensional curved surface; and a visualization of a part volume comprising said specified three-dimensional curved surface.

In accordance with certain aspects herein a surface transition equation is determined using at least one of: a mathematical equation; a specification; a plane curve equation that characterizes at least one plane curve computed from the intersection of a specified three-dimensional curved surface by at least one of parallel slice planes; an approximative equation used to approximate the specified three-dimensional curved surface over an interval bounded by the at least two parallel slice planes; a cross section of a tessellated part volume that comprises the specified three-dimensional curved surface; at least one derivative or partial derivative computed from a cross section equation that characterizes a cross section of the specified three-dimensional curved surface; and at least one gradient computed from at least one point located on or between the at least two parallel slice planes.

According to still other aspects in accordance with the present invention, a distance between at least two parallel cross sectional slice planes is at least one of: fixed; variable; and adaptive.

In accordance with another aspect herein, at least one solidification region is located between a plane curve found from the intersection of a specified three-dimensional curved surface with a slice plane and at least one of: a second plane curve computed from the intersection of a slice plane with at least one additional continuous or piecewise continuous surface; a second plane curve computed from the intersection of a slice plane with a boundary surface; a second continuous or piecewise continuous boundary plane curve; a boundary interval; and a boundary determined by slicing a tessellated part file.

According to other aspect herein, the step of generating at least one set of 3D printing instructions to selectively solidify a photopolymer build material comprises at least one of: generating a two-dimensional illumination mask image with at least one grayscale pixel value; generating a temporal mask illumination intensity function; generating a spatial-temporal laser beam deflection path; and generating a spatial-temporal laser intensity function. Those skilled in the art will recognize these elements as elements that are required to operate MIP-SL and SLA 3D printers.

In accordance with other aspects herein, the step of generating at least one set of 3D printing instructions is performed after solidifying at least one portion of said photopolymer build material. Generating 3D printing instructions in real-time can advantageously reduce the amount of data stored by, data transmitted by, or data transmitted to, the hardware controller. Furthermore, generating 3D printing instructions after solidifying at least one portion of said photopolymer build material permits for the compensation for current operating conditions, such as the photopolymer temperature, and allows for corrections caused by slight operating errors and noise that may affect the accuracy of the part being built.

According to certain aspects herein at least one set of 3D printing instructions is generated or modified in response to a measurement of at least one of: a solidified part geometry; a portion of an actinic exposure that is delivered to at least one portion of a build material over a specified time interval; a mask illumination source intensity; an optical phase delay provided by a spatial light modulator; a photopolymer temperature; an illumination source temperature; a laser source intensity; a laser beam deflection path; and a position signal provided by a beam steering, beam displacement or beam scanning component.

In accordance with other aspects of the present invention, at least one set of 3D printing instructions is interpreted by a hardware controller that controls an operating condition of at least one of: an illumination source; an optical modulator; an optical shutter; a liquid crystal filter; a beam steering, beam displacement, or beam scanning component; a temperature controller; a photopolymer wiper blade; a camera; a piezoelectric or MEMS actuator; a stepper or servo motor; and a spatial light modulator.

According to further aspects herein, the method of 3D printing a part using a photopolymer build material further comprises a processing step, wherein the processing step is selected from at least one of: polishing said 3D printed part; applying a coating to said 3D printed part; and post-curing said 3D printed part.

In accordance with still other aspects of the present invention, a method of fabricating a molded part from at least one 3D printed part comprises at least one of the following steps: casting; compression molding; injection molding; glass replication; and precision glass molding.

In accordance with yet other aspects herein, the method of fabricating a molded part from at least one 3D printed part further comprises the step of coating said molded part.

According to still other aspects herein, the method of fabricating a molded part from at least one 3D printed part further comprises an overmolding step in which additional material is added to said molded part using at least one additional mold part, said overmolding step comprising at least one of the following steps: casting; and injection molding.

Other objects and benefits of the disclosure will become apparent from the following written description along with the accompanying drawings.

### BRIEF DESCRIPTION OF THE DRAWINGS

The above-mentioned aspects of the present invention and the manner of obtaining them will become more apparent and the invention itself will be better understood by reference to the following description of the embodiments of the invention taken in conjunction with the accompanying drawings, wherein:

FIG. 1 is an example of a curved surface characterized by mathematical equation and a specification in accordance with the teachings of the present invention. In this example, the curved surface is described in cylindrical coordinates using Equation 2 with a specified conic constant of zero, a curvature of 0.01 mm⁻¹ and a maximum surface radius of 12.7 mm;

FIG. 2 is an example of a three-dimensional part to be 3D printed, which includes the curved surface of FIG. 1;

FIG. 3A shows the curved surface of FIG. 1 intersected by two parallel slicing planes;

FIG. 3B shows a plane curve used to described the curved surface of FIG. 1 using Equation 2. The plane curve is intersected by two orthogonal slicing planes. A three-dimensional part solidification region is specified as the region between the plane curve that is bounded by the slicing planes and a boundary radius of 15 mm;

FIG. 4 is a schematic of a magnified photopolymer build area that is separated by the 3D printer's layer height;

FIG. 5 is a schematic used to illustrate the shape of the cumulative exposure achieved from a scanned Gaussian laser spot between two fixed points;

FIG. 6 is an example of a radially-dependent cumulative exposure dose computed to solidify a portion of the curved surface of FIG. 1, in accordance with the teachings of the present invention;

FIG. 7 is a schematic used to illustrate a spiral scanning toolpath and a mask image that can be used to build a layer of the part shown in FIG. 6 in accordance with the teachings of the present invention;

FIG. 8 is a schematic diagram of a 3D printer that is configured to use both a scanning laser and a mask image projection illumination module.

### DETAILED DESCRIPTION OF THE INVENTION

The above-mentioned aspects of the present application and the manner of obtaining them will become more apparent and the teachings of the present application itself will be better understood by reference to the following description of the embodiments of the present application taken in conjunction with the accompanying drawings.

The embodiments of the present invention described herein are not intended to be exhaustive or to limit the invention to the precise forms disclosed in the following detailed description. Rather, the embodiments are chosen and described so that others skilled in the art may appreciate and understand the principles and practices of the present invention.

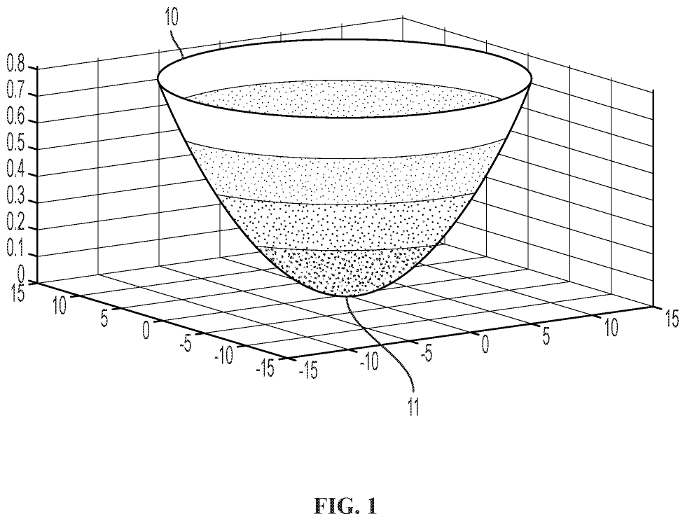

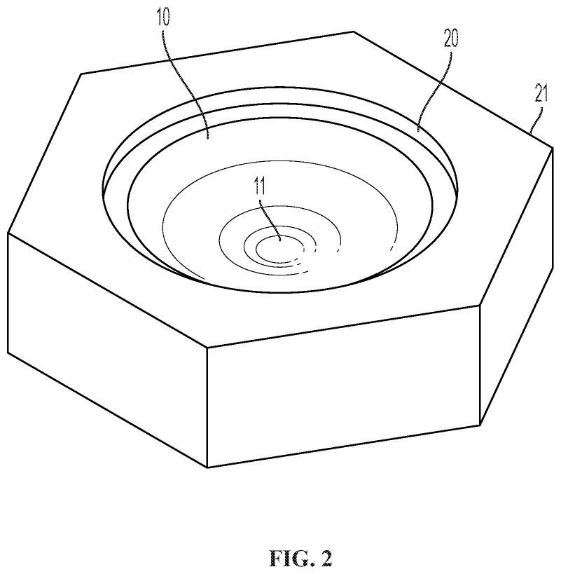

In accordance with a preferred embodiment of the present invention, a part is 3D printed using a photopolymer build material. In this preferred embodiment, the photopolymer-specific relationship between an actinic exposure and a photopolymer solidification thickness is characterized by Equation 1, with the characteristic penetration depth and critical exposure determined for the 3D printer's photopolymer build material using well-known photopolymer calibration techniques. The part to be 3D printed features a three-dimensional curved surface (10) that is characterized using an optical sag equation, provided by Equation 2, and is specified by a conic constant, a radius of curvature and a maximum radius, shown as an example in FIG. 1 using a representative conic constant of 0, a radius of curvature of 0.01 mm, and a maximum radius of 12.7 mm. In this preferred embodiment, the part to 3D print is shown schematically in FIG. 2 and comprises a template CAD part (21) that is combined with the curved surface (10) and a pre-determined boundary radius (20). In this representative example, the curved surface (10) is centered laterally on the template CAD part (21) and positioned such that the minimum curved surface height (11) is several millimeters above the bottom of the template CAD part (21).

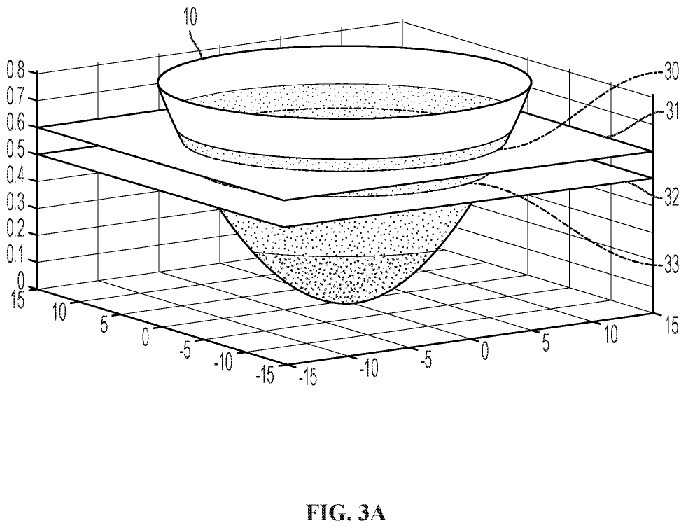

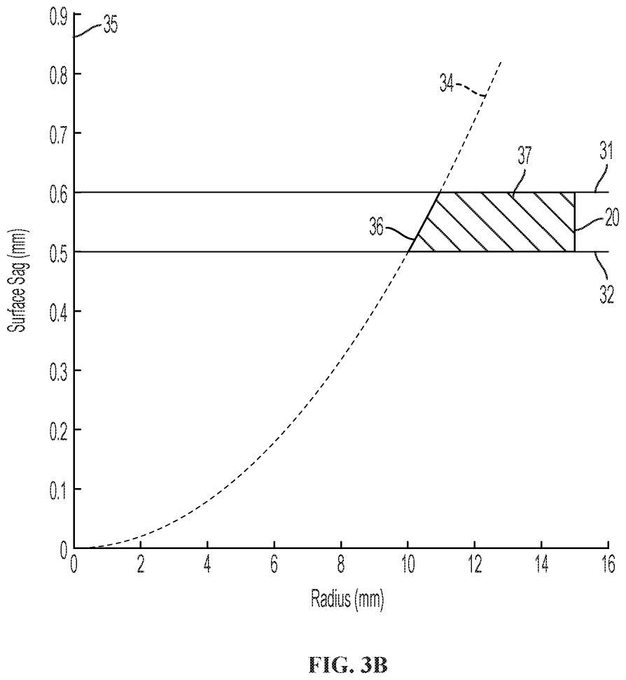

The curved surface (10) is sliced using two parallel slice planes (31) and (32), as shown in FIG. 3A. The dashed lines (30) and (33) schematically depict the intersection between the curved surface (10) and the respective slice planes (31) and (32). The intersection lines (30) and (33) form cross-sectional contours of the surface. In this preferred embodiment, intersection lines (30) and (33) are circular with a radius found using Equation 4.

FIG. 3B shows the single-sided radial plane curve (34) that, when revolved about the height or surface sag axis (35), forms the three-dimensional curved surface (10). In this preferred embodiment, the spacing between the parallel slice planes (31) and (32) is equal to a pre-determined layer height used by the 3D printer, shown in FIG. 3B using a representative layer height of 0.1 mm. The surface transition is the region of the three-dimensional curved surface (10) that is bounded by the parallel slice planes (31) and (32), and is characterized by a surface transition equation, which in this preferred embodiment is also provided by Equation 2. FIG. 3B shows the single-sided plane curve of the surface transition (36). A two-dimensional cross-section of the solidification region (37) is shown as the region bounded by the parallel slice planes (31) and (32), the surface transition plane curve (36), and the boundary radius (20). The three-dimensional solidification region is formed when revolved about the height axis (35). In this preferred embodiment, a representative value of 15 mm is used for the boundary radius (20), which is greater than the specified 12.7 mm maximum radius of the curved surface (10).

In this preferred embodiment, the 3D printer is configured to use scanned laser illumination to solidify the three-dimensional solidification region. The remaining part volume defined by the template CAD part (21) that extends beyond the boundary radius (20) and below the minimum curved surface height (11) is 3D printed using mask-image projection illumination provided by a spatial light modulator.

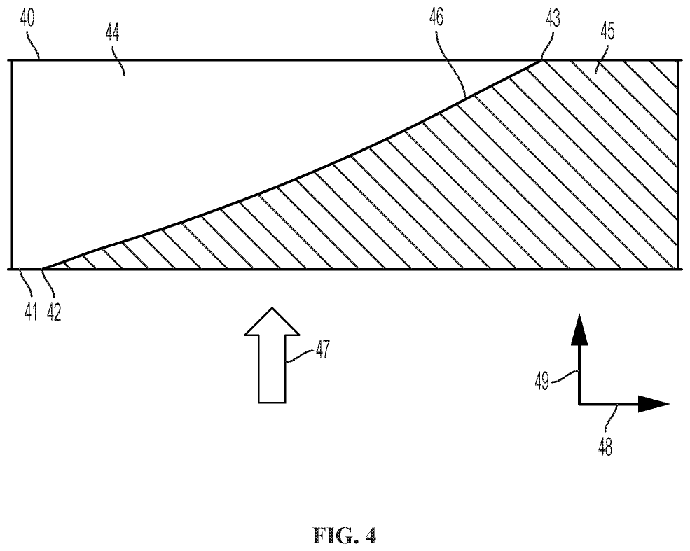

In this preferred embodiment, each layer is partially cured over a radial interval according to the surface transition equation. Partial layer curing is shown schematically in FIG. 4 for a magnified, single-sided, cross-section of a 3D printing layer. In this preferred embodiment, actinic illumination is provided from below in an upwards direction, as indicated by an arrow (47), and the directions of positive surface height (49) and positive radius (48) are provided. The direction of positive surface height and positive curing depth are the same. The 3D printing build layer is bounded by an upper layer boundary (40) and a lower layer boundary (41), which are coincident with slicing planes (31) and (32), respectively, and separated by the 3D printer's specified layer thickness. In this arrangement, the solidification of the photopolymer proceeds from the lower layer boundary (41) to the upper layer boundary (40), with the lower layer boundary (41) also referred to herein as a build surface or a 3D printer build plane. The photopolymer material receives a cumulative exposure dose that solidifies the photopolymer material according to the three-dimensional solidification region, with a radial-depth curing profile (46) that closely approximates the desired surface transition plane curve (36). After curing the solidified photopolymer material (45), the 3D printer's build plate is raised and non-solidified photopolymer material (44) drains off the partially-built part prior to solidifying the next layer. In this preferred embodiment, non-solidified photopolymer material (44) that remains on the curved surface (10) is removed during part cleaning after 3D printing is completed and prior to post-curing. The starting radius (42) and ending radius (43) correspond to the radius of the intersection lines (30) and (33) between the curved surface (10) and the slicing planes (31) and (32), respectively, and can be computed using Equation 4.

In this preferred embodiment the surface transition and surface transition equation is circularly symmetric and the 3D printing instructions specify a time-varying laser power and a time-varying sinusoidal amplitude and frequency to use to drive a pair of XY galvanometer scanners in quadrature. The pair of in-quadrature sinusoidal driving signals that are generated using the 3D printing instructions trace a circular laser path to solidify the photopolymer material. The sinusoidal signal amplitude is proportional to the traced path radius, and the sinusoidal signal frequency is proportional to the angular velocity of the traced path. A DC offset is applied to the sinusoidal signal to set the center position of the part relative to the 3D build platform.

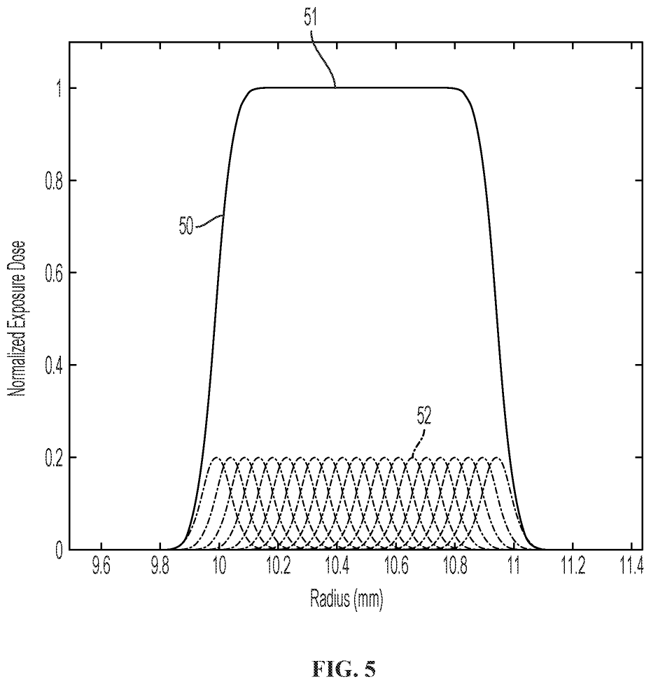

In this preferred embodiment, a smooth cumulative exposure dose is achieved by continuously scanning a focused Gaussian laser spot. As known from prior art, when a Gaussian laser is scanned between two finite points, the peak of the cumulative exposure at the surface of a target will transition from zero to a plateau in regions near the starting scan point, and will transition from the plateau back to zero near the ending scan point. The transitions in the peak cumulative exposure follow the Gauss error function when the Gaussian spot is scanned continuously, and reach 99.5% of the plateau when the distance from the start or end point equals 1.414 times the 1/e² Gaussian beam half-width. FIG. 5 is a plot of the peak cumulative exposure computed over a radial scan path extending from 9.9 mm to 10.9 mm, using a representative 1/e² Gaussian beam half-width of 0.1 mm and a constant step size. The peak cumulative exposure features a transition region (50) and a plateau region (51). A sequence of smaller Gaussian profiles (52) are shown representatively, and is summed to determine the peak cumulative exposure. Note that only a subset of the smaller Gaussian profiles (52) that contribute to the peak cumulative exposure are shown for clarity, and that they are not drawn to scale.

In this preferred embodiment, an approximately planar cumulative exposure at the build plane is achieved in two dimensions by continuously scanning a Gaussian laser spot in a spiral pattern. To achieve a small amount radial ripple in the cumulative exposure, the radial spacing for each full rotation of the spiral path is set to be less than the 1/e² beam half-width of the focused Gaussian laser spot used to solidify the photopolymer material in the region bounded by the upper layer boundary (40) and lower layer boundary (41). The linear velocity of the scanned trace is constant, and is achieved by specifying a sinusoidal frequency in the 3D printing instructions that is inversely proportional to the trace radius and sinusoidal amplitude. With constant linear and radial scan velocities, and a small radial spacing with respect to the beam width, the cumulative surface exposure is approximately equal to the convolution of the Gaussian laser beam shape and a spatial-temporal laser intensity function, which is set to vary radially in synchrony with the XY scanner's sinusoidal driving signals.

The cumulative surface exposure needed to solidify photopolymer material according to the surface transition equation is determined from a photopolymer-specific relationship which, in this preferred embodiment, is described using Equation 1. Once the characteristic penetration depth and critical exposure are determined through calibration, the maximum exposure Eₘₐₓ that results in a cure depth equal to the 3D printer's layer height z_{L} can be computed. These variables can be substituted into Equation 1:

$${z}_{L} = {D}_{p} ln ( \frac{{E}_{ma x}}{{E}_{c}} ) \qquad ( 5 )$$

Likewise, the radially-dependent curing depth for a given layer, z(r)−z(r₀), can be substituted into Equation 1, together with a radially-dependent exposure E(r). The height z(r₀) is the surface height of the intersection line (33) made between the surface (10) and a slicing plane (32). The radius r₀ is the radius of the intersection line (33) and can be computed using Equation 4.

$$z ( r ) - z ( {r}_{0} ) = {D}_{p} ln ( \frac{E ( r )}{{E}_{c}} ) \qquad ( 6 )$$

Equation 6 is divided by Equation 5 and simplified to provide the radially-dependent exposure needed to cure a desired radial depth profile within a layer bounded by z(r₀) and z(r₁).

$$E ( r ) = {{E}_{c} ( \frac{{E}_{ma x}}{{E}_{c}} )}^{α} , α = \frac{z ( r ) - z ( {r}_{0} )}{z ( {r}_{1} ) - z ( {r}_{0} )} \qquad ( 7 )$$

where z(r) is the radially-dependent depth, equal to the surface transition equation, r is the surface radius, and r₀ and r₁ are the upper and lower radii determined by Equation 4 for a given layer being printed. Note that the 3D printer's layer height, z_{L} is equal to z(r₁)−z(r₀) and, for the interval spanning r₀ to r₁, the exponent α varies from zero to one.

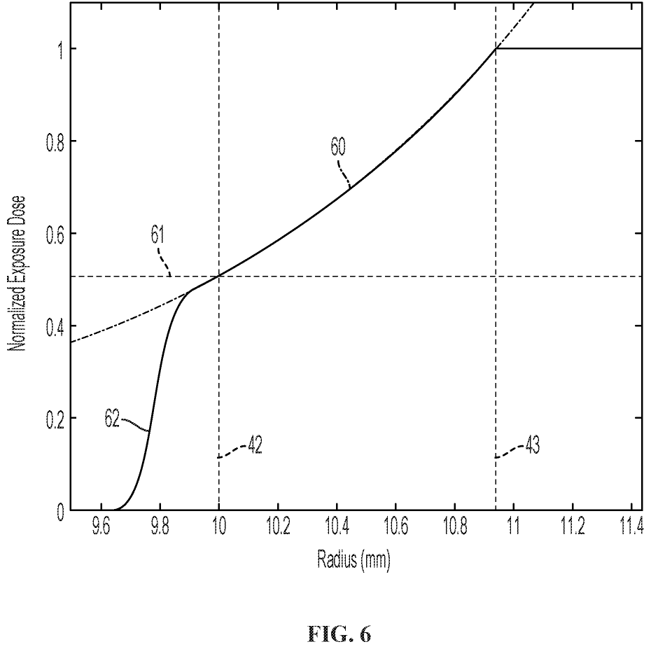

FIG. 6 shows a plot of the exposure dose computed for a layer bounded by slicing planes (32) and (33) that intersect the curved surface (10) at a surface sag of 0.5 mm and 0.6 mm, respectively. Representative values of 6.8 mJ/cm² for the critical exposure and 0.147 mm for the penetration depth were used. The radially-dependent exposure was calculated assuming a constant linear and radial scan velocity and was normalized according to Eₘₐₓ, the exposure required to achieve a cure depth equal to the layer height z_{L}. Solidification will occur when the cumulative exposure (60) is above the critical exposure line (61). Vertical dashed lines show the starting radius (42) and ending radius (43). The cumulative exposure is flat and equal to Eₘₐₓ over the region extending from the ending radius (43) to the boundary radius (20), resulting in the desired uniform full-layer cure of the photopolymer material for this region. In this preferred embodiment, the cumulative exposure that cures a radial depth profile that approximates the surface transition equation is achieved by starting the radial exposure at a radius that is less than the starting radius (42). Starting the radial exposure at a radius that is less than the starting radius (42) ensures that the transition region (62) of the cumulative exposure curve (60) does not affect the cured radial depth profile (46). FIG. 6. starts the radial exposure at a representative distance of 0.212 mm prior to the starting radius (42). With a representative 1/e² Gaussian beam half-width of 0.1 mm, the error function is computed to be 0.9998, indicating that the transition region (62) has approximately ended at the starting radius (42). Since the cumulative exposure provided in the transition region (62) is below the critical exposure line (61), it will not solidify the material and will be washed away prior to building the subsequent layer.

In this preferred embodiment, the cumulative exposure (60) that is calculated from Equation 7 is directly proportional to the laser intensity in regions where the surface transition is slowly varying with respect to the 1/e² Gaussian width. In these slowly varying regions, the convolution between a spatially small Gaussian laser irradiance function and a relatively much larger spatial-temporal scanned laser intensity function is approximately equal to the spatial-temporal scanned laser intensity function multiplied by a constant. In regions where the surface transition equation, and associated cumulative exposure function vary quickly, such as at a sharp surface discontinuity, the cumulative exposure that is actually achieved by the scanned laser will be a low-pass filtered version of the cumulative exposure, computed using the laser irradiance function as the filter. The low-pass filtering effect on the cumulative exposure can be determined analytically or simulated numerically, using a one-dimensional or two-dimensional laser irradiance function. In this preferred embodiment, the three-dimensional curved surface (10) and surface transition varies slowly with respect to the size of the Gaussian beam. The transition region (62) of the cumulative exposure (60) is a region where a low pass filtering effect is observed. When the starting radius (42) is zero, the transition region (62) disappears and the spiral scan path is started at a radius of zero.

The relationship between the laser intensity and cumulative exposure, and the associated curing depth, can be determined by calibrating the photopolymer resin using a planar cumulative surface exposure generated by a spiral scanning path. This process is similar to traditional methods of using planar exposures for photopolymer calibration, except that the plane is created in polar coordinates rather than Cartesian coordinates and the angular velocity is decreased proportionally with the spiral radius. Curing depth measurements are preferably performed halfway between the starting and ending radius of the spiral path, to avoid any transition effects. As with traditional methods, the laser intensity, linear scanning velocity, and hatch spacing, which in this case corresponds to the radial spacing, are initially estimated to determine a range that permits curing depths to at least the 3D printer's layer height. In this preferred embodiment, the laser current and scan parameters are precisely calibrated for a curing depth equal to the 3D printer's layer height. Measurements for curing depths that are less than the 3D printer's layer height are also preferentially performed to precisely determine the relationship between the laser current, laser intensity and cumulative surface exposure when the scanning geometry and linear scan velocity remain fixed.

By calibrating the laser intensity to the cumulative exposure, a radially-dependent laser current is determined based on E(r) and is synchronized to the sinusoidal signal to drive the XY scanning mirrors. In this preferred embodiment, the scanning amplitude, scanning frequency, and laser current that are used by the 3D printer to deliver a controlled actinic exposure to solidify photopolymer material comprise the 3D printing instructions.

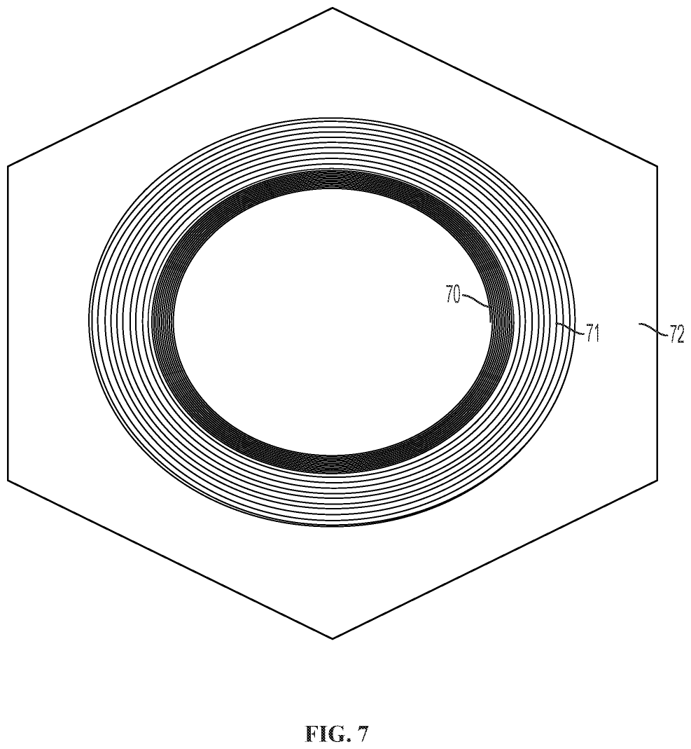

FIG. 7 shows a top-down view of a laser scanning toolpath for 3D printing the layer shown in FIG. 3A that is bounded by slicing planes (32) and (33) that intersect the curved surface (10) at a surface sag of 0.5 mm and 0.6 mm, respectively. A dense spiral scan pattern (70) with a radial spacing that is less than the 1/e² Gaussian half-width is used to create a radial-depth curing profile (46) of FIG. 4 that closely approximates the desired surface transition plane curve (36) of FIG. 3B. The spiral scan pattern's radial spacing becomes coarser for the scan region (71) that extends from 0.212 mm past the ending radius (43) to the boundary radius (20) of FIG. 3B. Those skilled in the art will recognize that a coarser radial spacing that is greater than the 1/e² Gaussian half-width can be used for scan region (71) to reduce the time required to solidify the interior part portion of each layer while having minimal effect on the radial-depth curing profile (46). The outer solidification region (72) extends from the boundary radius (20) to the geometry of the sliced template CAD part (21). This outer solidification region (72) is solidified to the full layer height using a mask-image provided by a separate mask-image projection module. The mask-image projection module is calibrated so that the field uniformity of its projected image is corrected, the exposure and pixel settings required to cure a full-layer depth is known, and the spatial positioning of the mask image is known with respect to the spatial location of the scanned laser at the build plane. Spatial correspondence between the scanned laser and mask image pixels can be performed visually by overlaying a mask image and laser scan, such as a set of concentric circles, or by imaging the build plane with a camera and computing a spatial transform in post-processing.

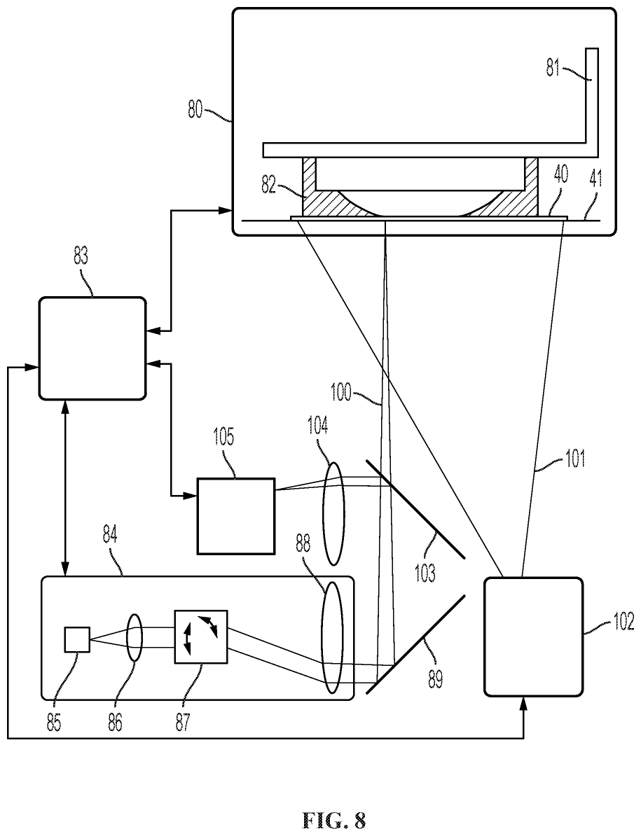

In this preferred embodiment, a photopolymer-based 3D printer is configured to use both scanning laser and mask-image projection actinic exposures, as shown schematically in FIG. 8. In FIG. 8, the 3D printing apparatus (80) includes the upper layer (40) and lower layer (41) boundaries where photopolymer resin is solidified according to the cross-sectional geometry of the part. A schematic cross-section of a partially built part (82) is shown. After each layer is added to the partially built part (82), it is peeled from the build surface, which is the lower layer boundary (41), by raising build stage (81). A fresh coat of photopolymer resin is applied to the lower layer boundary (41) using a wiper blade that is not shown, and the partially built part is lowered to the upper layer boundary (40), where it is in contact with the newly applied liquid photopolymer material. Photopolymer solidification is achieved using a scanning laser illumination module (84) or a mask-image projection module (102). In this preferred embodiment, the mask-image projection module (102) is a digital light projector that uses an ultraviolet illumination source, such as an LED, laser or lamp and features a 100% illumination offset. A 100% illumination offset is a common feature of consumer digital light projectors, and enables its side-by-side use with the scanning laser illumination module (84) without the need for a separate beam combining component. The scanning laser illumination module (84) comprises a UV laser illumination source (85), a collimating lens (86), an XY pair of galvanometer scanning mirrors (87), and a telecentric scan lens group (88). The telecentric scan lens group (88) is comprised of one or more lens elements that focuses the scanned laser light in a telecentric manner across a specified scan angular range. The scanned laser light is focused onto the photopolymer resin located between the upper layer (40) and lower layer boundary (41) at normal incidence. An optional folding mirror (89) is used to redirect the scanned laser light from the scanning laser illumination module (84) to the 3D printing apparatus (80) and can be used to adjust the spatial correspondence between the scanned laser illumination (100) and mask-image projected illumination (101) at the lower layer boundary (41). The photopolymer material can be solidified using either scanned laser illumination (100) or mask-image projected illumination (101). Those skilled in the art will appreciate that the mask-image projection module (102) is used to save time in this preferred embodiment, that it does not contribute to building the curved surface, and that the entire part could be 3D printed using only the scanning laser illumination module (84). Those skilled in the art will appreciate that the telecentric scan lens group (88) is not typically used on SLA 3D printers and is used to simplify the generation of the 3D printing instructions by using normal incidence across the laser scanning range. As known by those skilled in the art, a scanned Gaussian beam at normal incidence will produce a planar cumulative exposure profile, and that non-normal incidence will change the shape of the cumulative exposure profile. A related embodiment does not use a telecentric scan lens group, and incorporates a non-normal incident beam irradiance model into the calculation of the exposure needed to cure a desired radial-depth profile (46).

In this preferred embodiment, a portion of the scanned laser illumination (100) is picked off by a partially reflecting beamsplitter component (103) and focused by lens group (104) onto a camera (105). The camera (105) is used to measure the scanned laser exposure delivered to the photopolymer resin and to provide feedback to the 3D printing instructions that control the driving signals used to operate the laser source (85) or the scanning mirrors (87). In this preferred embodiment, the magnification provided by lens group (104) provides a field of view that permits imaging at least a section of the dense spiral scan path (70) shown in FIG. 7. The camera (105) is configured to use an exposure time that is longer than that required to trace the portion of the dense spiral scan path being imaged. In this preferred embodiment, an image of a portion of the dense spiral scan path (70) is acquired and processed to determine differences between the actual and desired exposure delivered to the photopolymer resin, and a second scanning path and laser power function is optionally generated to correct deficiencies. In this preferred embodiment, the partially reflecting beamsplitter component (103), lens group (104) and camera (105) is also optionally used for calibrating the exposure delivered by the scanning laser module (84), and may be optionally removed after calibration. In related embodiments, the lens group (104) is a lens group that is operated electrically or mechanically to set and adjust the magnification and focus of the image on the camera. In this related embodiment, the magnification and focus of the image on the camera is adjusted depending on the radius of the arc currently being traced and is controlled using the hardware controller module (83).

In this preferred embodiment, a hardware controller module (83) is used to control the build stage (81) of the 3D printing apparatus (80), the laser power of laser source (85), the scanning motion of the scanning mirrors (87), and the mask image being displayed by the mask-image projection module (102). In this preferred embodiment, the hardware controller module (83) includes a computer that receives and processes images provided by the camera (105), as well as the necessary electronics needed to generate the driving signals necessary to control the build stage (81), laser power source (85), the scanning mirrors (87), and the mask-image projection module (102). FIG. 8 shows two-way arrows between each module controlled by the hardware controller module (83) to indicate that two-way communication is additionally performed to monitor operating temperature, build stage position and scanning mirror position, and to configure and verify hardware settings and to synchronize timing between the various hardware components. The laser intensity is preferentially varied by changing the laser drive current, but may also be varied using other common techniques, such as by changing the modulation of the laser drive current signal, or by changing an active component placed in the optical pathway. Examples of active components used to adjust the laser intensity delivered to the photocurable resin include: an optical shutter, a variable attenuator, a liquid crystal filter operable to vary the laser polarization, an active diffractive optical element, and an acousto-optic modulator. If changes to the laser intensity alone cannot achieve a desired radial-depth profile, the desired cumulative exposure can also be modified by adjusting the linear scan velocity of the spiral scanning path. As those skilled in the art will appreciate, the cumulative exposure is inversely proportional to the linear scan velocity and synchronized changes to the linear scan velocity and the laser intensity can be used to extend the dynamic range of the cumulative exposure provided by either the laser intensity or scanner speed alone. In this case, the proportional relationship between the laser intensity, scanner speed, and cumulative exposure is applicable in a region of a surface transition that is slowly varying with respect to the spatial extent of the laser irradiance function.

Related embodiments feature a hardware controller module (83) that includes a microprocessor or a field-programmable gate array. In these related embodiments, the hardware controller module is pre-programmed to generate instructions for a known mathematical equation. A specification in the form of surface parameters, boundary conditions, and the slice plane heights is provided, and the hardware controller automatically generates 3D printing instructions that are used for solidifying a surface profile that approximates the desired surface transition. In these related embodiments, a computer or other hardware controller is used to separately control the mask-image projection module (102).

In this preferred embodiment, the 3D printed part is used in a 2-part mold to fabricate an optical lens using an injection molding machine. The specification provided is a specification for a lens, which features two optically smooth surfaces that are characterized by the optical sag equation provided by Equation 2. The specification is provided electronically using a website and includes: a conic constant, a radius of curvature for each of the two surfaces, a lens diameter and an optical material to use to mold the lens. A 2-part mold of the lens is automatically generated using template CAD mold plates, the lens surfaces and a desired cutting line. Molding channels, runners, tunnels, vents, gates, holes, mount points, or guide pins are automatically added to the part based on the geometry of the specified lens surface using a combination of template B-rep CAD shapes, features defined by mathematical equations, and shapes defined using constructive solid geometry. A flange is added to the specified diameter of the lens in the form of the boundary radius (20). The flange is added to assist with optical mounting and its outer edge may include draft, defined by a boundary radius that changes with part height, to help remove or eject the lens from the mold. In this preferred embodiment, the characterized surface is scaled to account for distortion of the solidified photopolymer material and for the injection molded part. In accordance with the teachings of this invention, both of the two mold parts are 3D printed. The molds are post-cured at an elevated temperature to improve their mechanical strength and heat resistance, and are then used to injection mold the lens with the specified optical material. The injection molded lens is optionally coated with an anti-reflection coating or other protective coating, and is optionally tested, inspected, and characterized for surface roughness, geometric accuracy, and optical performance. In related embodiments, the 3D printed molds are used to fabricate a lens using casting, compression molding, glass replication or precision glass molding processes that are well-known to those skilled in the art.

An advantage of this preferred embodiment of the present invention is the ability to offer a wide range of optical materials that can be used to mold an optical component. Photopolymer materials do not presently have the full range of optical characteristics as found in optical glass or optical plastic, and customers may desire parts with certain optical characteristics, such as: refractive index, dispersion, absorption, scattering, luminescence, optical gain, nonlinear optical response, or birefringence, or with certain material properties such as thermal stability, mechanical strength and durability, ability to be optically coated, weight, or cost. Another advantage of this embodiment is the ability to rapidly produce several duplicates of the optical component using the 3D printed mold parts. A potential advantage of this preferred embodiment is the ability to 3D print with a photopolymer resin that provides an excellent optical surface quality, but does not otherwise have one or more optical or material characteristics desired in the final optical component. Another potential advantage of this preferred embodiment is the avoidance of a change in the desired optical or material final part properties that occurs as a result of the 3D printing process. Another potential advantage of this preferred embodiment is the ability to 3D print a mold part that does not have the desired optical surface quality, but that can be used to cast a part with optical surface quality attained through slight molding material shrinkage and surface tension.

In a related embodiment, a curved mirror substrate part is 3D printed in accordance with the teachings of the present invention. In this embodiment, a reflective coating is applied to the curved mirror substrate part in post-processing using techniques that are well-known to those skilled in the art. In another related embodiment, a curved mirror substrate is molded from a two-part mold, with at least one part of the two-part mold being a 3D printed part that features a three-dimensional curved surface characterized by a mathematical equation and a specification. A reflective coating is applied to the molded mirror substrate part using techniques that are well-known to those skilled in the art.

In a related embodiment, an optical component is molded from a two-part mold wherein one part of the two-part mold is a 3D printed part that features a three-dimensional curved surface characterized by a mathematical equation and a specification. The second part of the two-part mold does not feature an optically smooth surface and is machined or 3D printed using techniques well-known to those skilled in the art.

In a related embodiment, a part featuring an optically smooth surface is 3D printed using the teachings of the present invention. The surface roughness of the 3D printed part is reduced in post-processing by polishing. In a related embodiment the surface roughness of the 3D printed part is reduced in post-processing by applying one or more thin coatings, using for example the photopolymer material used to print the part or a two-part epoxy. Coating uniformity is obtained by spin coating, or gravity prior to solidification.

In a related embodiment of the present invention, a 3D printed part is the inverse of the mold plate used in a 2-part mold. In this embodiment, a smoother or more accurate surface profile can be attained by 3D printing an inverse of the curved surface due to the part geometry and 3D printer architecture. This embodiment is particularly well-suited to molding an optical component with a concave surface shape that cannot be in physical contact with the build plate. In this embodiment, a mold plate is obtained by casting the 3D printed part. The mold plate is then used in a 2-part mold in an injection molding machine to produce an optical component using the specified optical material.

In a related embodiment, two 3D printed parts are used in a 2-part mold to produce more than one optical component. In this embodiment, more than one characterized curved surface is arranged on a template CAD mold plate. Molding channels, runners, tunnels, vents, gates, holes, mount points, or guide pins are automatically added to the part based on the geometry of the specified lens surfaces. The geometry between the optical component surfaces may be determined automatically, based on mold filling rates and methods well known in the art to improve mold yields and the quality of molded parts. A DC offset is applied to the sinusoidal driving signals used to operate the galvanometer scanning mirrors in order to solidify photopolymer material for each of the displaced curved surfaces in turn.

In a related embodiment, an optical component is molded from a two-part mold wherein at least one part of the two-part mold is a 3D printed part that features a three-dimensional curved surface characterized by a mathematical equation and a specification. A further overmolding step is performed in which new material is added to the molded optical component using casting or injection molding. A benefit of the additional overmolding step is to incorporate geometry to facilitate optical mounting, positioning or alignment in an optical-mechanical system. The molds required for the overmolding step may be 3D printed or machined using standard techniques.

Those skilled in the art will recognize that the teachings of the present invention are not limited to 3D printing surfaces described by the optical surface sag equation provided by Equation 2, and that related embodiments exist that use any continuous or piece-wise continuous analytic surface equation that can be 3D printed. Those skilled in the art will recognize that while Equation 7 indicates a radial dependence on the exposure and surface transition equation, Equation 7 equally describe functions that are angularly dependent, radially and angularly dependent, dependent on Cartesian coordinates, or dependent on another three-dimensional coordinate system that is selected for expressing the exposure function or surface transition equation. Those skilled in the art will recognize that the mathematical equation used to characterize the curved surface can be described in three-dimensions, or as a plane-curve in two-dimensions that is extended to a three-dimensional surface. The mathematical equation can itself be specified as a closed-form implicit or explicit equation, or as a generating function. Those skilled in the art will recognize that related embodiments exist in which a surface specification includes the coefficient of any term of the mathematical equation used to describe the curved surface, as well as a number of terms to include in an evaluation of a power series representation of a mathematical equation. When the surface is defined using a plane curve, the plane curve can be specified as a NURBS curve using control points. When the surface is defined as a conic section, the surface can be specified using parameters well-known in the art to specify conic shapes, such as an eccentricity, a focus point, a directrix line, a conic axis and a conic vertex. A surface or plane curve can be further specified using translational or rotational coordinates to indicate an orientation or position of the surface relative to the 3D printer's coordinate system. A description of the surface itself may also include a normal vector to indicate a solidification region that is above or below the surface, as well as at least one domain or piecewise sub-function that describes a spatial extent over which at least one portion of the surface is defined. Finally, those skilled in the art will recognize that the specification of a surface can be derived by fitting a known curved surface equation to a surface contained in a CAD file, a point-cloud file generated by a 3D scanning device or a coordinate measuring machine, or a table of sag coordinates, and that providing a CAD file, point-cloud or coordinates in this manner is functionally equivalent to specifying the surface directly.

A related embodiment of the present invention uses a scanned non-Gaussian laser source, such as a laser source that exhibits lateral or transverse multi-mode behavior, or a laser source that emits an elliptically-shaped irradiance function. Possible advantages of this related embodiment are a higher achievable laser power, a lower cost for the laser source or laser source driver electronics, less stringent temperature control requirements, improved laser stability, lower laser noise, and the availability of a laser source that emits light at a specified wavelength. In this related embodiment, a cumulative surface exposure is achieved by scanning the non-Gaussian laser source in a spiral pattern. In this embodiment, the shape of the transition region (50) for a planar cumulative exposure, and the transition region (62) for a cumulative exposure (60) that is calculated from Equation 7, will be different from that computed for a Gaussian-shaped laser beam. The shape of the transition region (50) may be simulated by measuring the laser irradiance with a camera, or characterizing the irradiance with an equation. Provided that the surface transition is slowly varying with respect to the spatial extent of the non-Gaussian laser irradiance, the cumulative exposure (60) that is outside the transition region (62) will be directly proportional to the laser intensity. In this embodiment, the same steps are performed to calibrate the photopolymer curing depth using a planar exposure achieved using a spiral scanning pattern at different laser source currents. An optical diffuser may optionally be inserted between the non-Gaussian laser source and the beam scanning component to change the laser irradiance at the 3D printer's build plane, for example, to a laser irradiance that has a more uniform intensity profile over a specified radial interval. A related embodiment uses a non-Gaussian laser source that exhibits spatial mode-hopping at different laser currents. In this related embodiment, the desired laser current specified by the 3D printing instructions is modulated with a high frequency signal. The high frequency signal is used to hop between spatial laser modes at a faster rate than the linear scan velocity so that the laser irradiance can be approximated by an average of the laser irradiance achieved from multiple laser modes.

Those skilled in the art will recognize that the teachings of the present invention are not limited to 3D printing surfaces of optical components, and that it could be applied to produce jewelry and artwork that feature mathematically-defined shapes with a desired smooth aesthetic. The teachings of the present equation could also be applied to 3D printing smooth surfaces for predictable and accurate operation of microfluidic channels.

A related embodiment of the present invention uses at least one 3D printing coordinate system that is defined relative to the coordinate system used to characterize the curved surface. In this embodiment, a coordinate transformation is performed to express the curved surface in the 3D printing coordinate system prior to being sliced by at least two parallel slice planes. In this embodiment, the 3D printed coordinate system is defined by a build plane and a build direction that is orthogonal to the build plane. The 3D printer's build stage moves in the direction of the build direction when 3D printing a part.

Related embodiments of the present invention exist for specifying boundary conditions used to defined the solidification region that intersects the curved surface. The boundary conditions may be specified electronically through a website, and may comprise a direction, a coordinate point or a vector that is defined relative to the surface. Those skilled in the art will recognize that an axis or plane curve may be used to define an extrusion path and boundary of the curved surface, and that a boundary surface may be defined by slicing a tessellated CAD part file or by a boundary surface mathematical equation.

The curved surface in the present invention can be characterized using a mathematical equation or specification that is transmitted electronically. Related embodiments of the present invention transmit the mathematical equation or specification using a software application, a plugin to a software application, electronic mail, a web site, a web application, and a plugin to a web application. An advantage of these embodiments is that it permits an optical designer to specify a custom optical component for manufacturing without the need to spend time creating or transmitting a CAD part file. Those skilled in the art will recognize that related embodiments exist in which the transmitted mathematical equation or specification is automatically reviewed and evaluated to discover potential errors in the surface, boundary, or part definition, or difficulties in 3D printing the part that features the curved surface. Errors may include any of: gaps in the solidification region, and part features that are discontinuous, overhang, are too large or too small, or have too large or small of a surface curvature to build within the desired operating tolerances of the 3D printer. Those skilled in the art will also readily recognize that related embodiments exist in which a transmitted specification and mathematical equation is combined with a user interface that provides a price quotation for 3D printing a part or producing a mold of a part, a manufacturing lead time, a visualization of the curved surface or a visualization of a 3D printed or molded part that features the curved surface and that can be updated in real-time. Those skilled in the art will also readily recognize that related embodiments exist in which a transmitted specification and mathematical equation is combined with stand-alone, web-based or cloud-based software that permits a secure monetary transaction to occur, that automatically notifies a customer of their order status and shipment tracking, and that automatically queues an ordered part for production.

Related embodiments of the present invention exist for determining the surface transition equation between two parallel slicing planes that intersect the curved surface. When the mathematical equation cannot be explicitly described along an axis that is perpendicular to the slicing planes, a Taylor series or other functional approximation of the mathematical equation may be used in its stead, or the surface transition equation can be approximated numerically using well-known techniques. Brent's, Newton's and the Newton-Raphson methods are examples of well-known numerical techniques used to find one-dimensional and multi-dimensional roots of an implicit mathematical equation. Newton's and the Newton-Raphson methods require the evaluation of both the function and an estimate of its derivative at points between the interval bounded by the parallel slicing planes. When convergent, these techniques can be used to evaluate the intersection contours between an analytic equation and a slicing plane at high resolution. Those skilled in the art will appreciate that the same process can be performed by slicing a tessellated part file that features a tessellated version of the curved surface and using the sliced contour points as starting points, or initial guesses, of the roots of the mathematical equation that characterizes the curved surface. In this related embodiment, these starting points are used to more quickly or more reliably converge to the true roots of the mathematical equation that characterizes the curved surface. A series of computed intersection contours can be used to approximate a piece-wise or continuous surface transition equation using well-known polynomial sequences, such as Chebyshev, Zernike or Hermite polynomials, cubic spline interpolation, or using a power series. In these related embodiments, although the surface transition equation is a numerical approximation to the mathematical equation used to characterize the curved surface, this approximation can be made at an exceptionally high resolution due to the exact equation-based representation of the surface. In these related embodiments, the spacing between two parallel cross-sectional slice planes may be fixed, variable, or adaptive depending on the shape of the curved surface, and the method used to approximate the surface transition.

In a related embodiment of the present invention, a continuous layer 3D printer is used to build the part. In these embodiments, the build stage (81) is continuously in motion and the lower layer boundary (41) features a semi-permeable window that uses oxygen inhibition to create a thin ‘dead-zone’ and prevent solidified photopolymer from sticking to the lower layer boundary (41). In this related embodiment, the separation between parallel slice planes is minimized and the surface transition equation approximates a spatial derivative, or the gradient, of the curved surface, which is computed algebraically or numerically. In a related embodiment that uses a continuous layer 3D printer to build a circularly symmetric curved surface, a spiral laser scanning pattern is used to solidify photopolymer material using a scanning speed that depends on the spiral radius and on the speed of the build stage. The laser power is adjusted in synchrony with the radius of the spiral scanning path to vary the slope of the solidified radial-depth profile. In a related embodiment, the speed of the build stage is varied to extend the range and resolution of the solidification slopes that can be achieved when varying the laser power alone. In this embodiment, the spacing between slicing planes is varied according to the speed of the build stage motion in a continuous layer printer.

In another related embodiment of the present invention, a mask image is used to cure a radial depth profile (46) that closely approximates the surface transition plane curve (36). In this embodiment, the mask image provided by a mask image projection module (102) is displaced or rotated with respect to the 3D printing apparatus (80). In this embodiment, the mask image displacement or rotation is achieved by displacing or rotating the mask image projection module (102), or by operating an optical actuator that causes a displacement or rotation of the mask image with respect to the 3D printing apparatus (80). The displacement or rotation is controlled by the hardware controller (83) in response to a driving signal voltage, driving signal current, or driving signal frequency that is specified by the generated 3D printing instructions. An example of such an optical actuator is a glass window that can be tilted in two-dimensions using a piezo-electric actuator and is placed near a plane that is conjugate to the lower layer boundary (41). The optical actuator may be placed inside the mask image projection module (102), in close proximity to the spatial light modulator. Another example of an optical actuator is a liquid crystal array, deformable mirror, or MEMS micromirror device that is capable of introducing an adjustable phase tilt to the wavefront of light that is directed to the lower layer boundary (41). Another example of an optical actuator is a dove rotating prism that is mounted in a motorized rotational mount. Another example of an optical actuator used to rotate an image is a pair of anamorphic optical elements, such as cylindrical lenses, which can be combined to form a saddle lens. In this related embodiment, pixel aliasing, a fill-factor of less than 1, and artifacts caused by the square pixel geometry are removed by the spatial displacement of the mask image at the build plane, creating a more planar surface cumulative exposure. The resulting exposure is a convolution of the mask image with the spatially shifted path, which acts as a low-pass filter and reduces the lateral resolution of the MIP-SL 3D printer while improving the smoothness of a slowly-varying solidified curved surface. In this related embodiment, the spatially shifted path is preferably a circular rotation of the field when 3D printing a part that features a circularly symmetric curved surface. The cumulative exposure of a rotated ring-shaped mask image is calibrated with varying pixel grayscale values and illumination source exposure times to determine the optimal grayscale values and illumination source exposure times required to achieve a curing depth equal to the 3D printer's layer height. In this embodiment, the illumination source exposure time is expected to be inversely proportional to the illumination area of the ring-shaped mask image; the precise relationship is determined by measuring rotated ring-shaped mask images, each generated with different ring radii, using a camera. In this embodiment, a stationary mask image is used to solidify part features that do not feature the curved surface and a scanning laser illumination module is not required. In a related embodiment, both a translational and a rotational change in the mask image is performed to set the position of the curved surface on the built plane (81).

In a related embodiment of the present invention, an optical surface is characterized in Cartesian coordinates. An example of such an optical surface is a cylindrical lens that has a surface sag defined in one dimension of a slicing plane. In this embodiment, the mask-image is displaced laterally by displacing a digital light projector, or by operating an optical actuator, in the direction that runs along the curved portion of the surface. The cumulative exposure of the displaced mask image at the photopolymer material is calibrated by setting the grayscale values of the mask image. A desired cumulative exposure that is designed to cure a depth profile that approximates the surface transition equation is computed and realized by setting the grayscale values of the mask image.

In another related embodiment of the present invention, an optical surface is characterized in Cartesian coordinates. An XY galvanometer scanner pair traces a series of parallel partially overlapping lines to create a smooth cumulative exposure across the surface being solidified. In this embodiment, the 3D printing instructions comprise a scanning speed, a hatch spacing, and a scanning amplitude that are used by the hardware controller to drive the XY galvanometer scanner pair.

In another related embodiment of the present invention, the XY galvanometer scanner pair is operated with a pair of sinusoidal driving signals that have proportionally different amplitudes. In this embodiment, the laser is traced in an elliptical path to create 3D printed part that features an elliptically-shaped surface.

In a related embodiment, an engineered optical diffuser is inserted between the Gaussian laser source (85) and the XY pair of galvanometer scanning mirrors (87) to modify the laser irradiance to one that is, for example, uniform over a desired radial range. In this related embodiment, one or more lenses is added to the scanning laser module (84) to focus the laser light onto the optical diffuser, and to collimate the diffused laser light so that the modified laser irradiance is scanned and focused near the 3D printing build plane (41).

In another related embodiment of the present invention, the XY galvanometer scanner pair is a resonant galvanometer pair with a fixed sinusoidal drive frequency and a continuous or stepwise adjustable amplitude. In this embodiment, the resonant XY galvanometer pair operates at a much faster speed than a standard XY galvanometer pair, requiring less time to solidify material with a desired radial-depth profile. In this embodiment, the increase in linear scan velocity with the radius of a circular scan path is compensated by proportionally increasing the laser intensity according to the radius.

In another related embodiment of the present invention, the XY galvanometer scanner pair is configured to trace a series of concentric circular paths. The radial spacing between adjacent circular paths is less than the 1/e² Gaussian beam half-width of the focused laser spot used to solidify the photopolymer resin. To avoid unwanted transients in the cumulative surface exposure, the scanner pair is driven with a sinusoidal amplitude and frequency in quadrature without an actinic exposure. At the start of a new circular trace, the actinic exposure is enabled via a change in the laser driving signal, or by opening a motorized shutter or other optical actuator or optical switch. After a prescribed number of complete circular traces, the actinic exposure is disabled via a change in the laser driving signal, or by closing a motorized shutter or other optical actuator or optical switch. The radius of the circular trace is incremented by the radial spacing and the process is repeated until the layer is partially solidified with a radial depth profile (46) that closely approximates the desired surface transition plane curve (36). In this related embodiment, multiple complete circular traces may help to reduce variations in the cumulative exposure caused by noise in the linear scanning velocity, scanning path, or in the laser intensity.

In another related embodiment of the present invention, the illumination source (85) and collimating lens (86) are mounted with a focusing lens and translated at a fixed distance from the lower layer boundary (41) using a pair of XY actuators. The XY actuators may be motorized, using stepper or servo motors, or may be controlled using a piezo-electric or MEMS actuator. The generated 3D printing instructions provide the laser power and the driving signals necessary to move the focused laser spot in a controlled manner to solidify the photopolymer material to a desired thickness. In a related embodiment, coarse motion of the focused laser spot is controlled using a motor and fine motion is controlled using a piezo-electric or MEMS actuator. In this related embodiment, the fine motion accuracy and precision can be further improved using positional sensor feedback provided to the hardware controller (83).

In another related embodiment, the 3D printer is configured to use two scanned laser illumination modules. In this embodiment, one scanned laser illumination module is used to solidify the region near the curved surface, while the second scanned laser illumination module is used to solidify interior regions and outer boundaries of the part. The addition of a second scanned laser illumination module serves to speed up the build process, and replaces the mask-image projection illumination module (102). Those familiar with the state of the art will appreciate that the second scanned laser illumination module does not require a telecentric scan lens group (88), which is often omitted from SLA 3D printers. The focus of the second scanned laser illumination module can be set by adjusting the distance of the collimating lens (86), or optionally adding an additional lens, usually prior to the XY scanners. In this embodiment, the generated 3D printing instructions comprise toolpaths and laser intensity functions for both the scanned laser illumination modules.

In another related embodiment of the present invention, multiple sets of 3D printing instructions are generated per layer and are performed sequentially to gradually add to the cumulative exposure dose. A benefit of this related embodiment is to more gradually cure the photopolymer to reduce heat build-up and associated 3D printed part distortion, to improve surface smoothness, and to more accurately deliver a desired exposure dose, particularly near surface boundaries and discontinuities. In this related embodiment, either a series of multiple mask images are used to solidify the photopolymer material, or a laser scanning path traces the same, or nearly the same, region of the photopolymer material multiple times. In this related embodiment, the use of multiple sets of 3D printing instructions increases the solidification time required per layer but provides an opportunity to correct the mask image, the mask image exposure, the laser power or laser scanning path with feedback provided by hardware components to the hardware controller module (83). In a related embodiment, at least one set of 3D printing instructions is created or modified in response to the sampled exposure dose measured by the camera (105) and processed by the hardware controller module (83).

In another related embodiment of the present invention, multiple sets of 3D printing instructions are generated per layer and are performed sequentially to gradually add to the cumulative exposure dose. In this related embodiment, the laser irradiance is varied between at least one set of 3D printing instructions by changing the diameter of the laser light collimated by lens (86) with the use of an iris that is optionally controlled with an actuator by the hardware controller module (83). In this embodiment, the 3D printing instructions are generated according to the laser irradiance function, which is calibrated in advance using a camera.

In another related embodiment of the present invention, multiple sets of 3D printing instructions are generated per layer and are performed sequentially to gradually add to the cumulative exposure dose. In this related embodiment, the 3D printing instructions are generated to deliver a cumulative exposure in a transition region where the convolution between the laser irradiance and temporal-spatial scanned laser intensity function does not produce a cumulative exposure that is directly proportional to the temporal-spatial scanned laser intensity function. In this related embodiment, the temporal-spatial scanned laser intensity function is determined by inverse filtering a desired exposure function with one or more laser irradiance functions using, for example, a Wiener filter, or other deconvolution methods well-known to those skilled in the art.

In another related embodiment of the present invention, multiple sets of 3D printing instructions are generated per layer and are performed sequentially to gradually add to the cumulative exposure dose. In this related embodiment, the 3D printing instructions are generated to deliver a cumulative exposure in a transition region where the convolution between the laser irradiance and temporal-spatial scanned laser intensity function does not produce a cumulative exposure that is directly proportional to the temporal-spatial scanned laser intensity function. The temporal-spatial scanned laser intensity function is determined approximately by acquiring a set of sample exposure doses and computing the least-squares approximation to the desired exposure function computed from Equation 7. In this related embodiment, the set of sample exposure doses is acquired using the camera (105) with varied known operating parameters, such as varied scanning geometries, scanning speed profiles, intensity profiles, and irradiance profiles. A matrix of the change in the exposure doses is determined that estimates the proportional effect that each operating parameter has on the shape of the cumulative exposure. The matrix is inverted using well-known techniques to find the least-squares solution for selecting several sets of operating conditions and 3D printing instructions that will approximate a desired cumulative exposure profile computed from Equation 7.

In another related embodiment, multiple laser irradiance functions are engineered to approximate at least one term of an orthogonal polynomial set that is used to approximate a desired cumulative surface exposure function determined from Equation 7. In this embodiment, the multiple laser irradiance functions are generated using an engineered optical diffuser, a deformable mirror, a liquid crystal on silicon chip, a liquid crystal display, or a similar optical device that is capable of altering a two-dimensional laser wavefront in a controlled manner. The wavefront altering device is controlled by the hardware controller module (83) in response to at least one set of 3D printing instructions.

In a related embodiment, at least one set of 3D printing instructions is created or modified in response to a measurement of the solidified part geometry. The solidified part geometry may be measured using scanning laser interferometry, low coherence interferometry, or other optical metrology techniques well-known to those knowledgeable in the state of the art. In this embodiment, the part geometry may be measured before, during or after an actinic exposure dose provided to solidify a portion of photopolymer material.

In other related embodiments of the present invention, the 3D printing instructions are used by the 3D printing hardware controller module (83) to control the temperature of the photopolymer resin, the temperature of the 3D printing module (80), the temperature of the laser source (85), the temperature of a spatial light modulator, or the temperature of the illumination source used in a mask-image projected illumination module (102). In related embodiments of the present invention, the 3D printing instructions are generated on a computer and transmitted via wireless communication, via wired communication, or via a memory chip to the hardware controller module (83) using a pre-determined communication protocol. The hardware controller module (83) interprets the 3D printing instructions and generates the driving signals necessary to operate the 3D printer and build the part featuring the three-dimensional curved surface.

In another related embodiment of the present invention, the computation of the cumulative exposure to cure a desired radial-depth profile (46) includes consideration of bleed through arising from the planned exposure dose to use on subsequent layers. This embodiment is particularly useful on 3D printers that are configured in a top-down orientation, in which a part is lowered down into a photopolymer resin bath during 3D printing and is susceptible to bleed through. This embodiment is also particularly useful on bottom-up oriented continuous-layer 3D printers, in which partially solidified regions of the part remain in a liquid photopolymer resin bath after they are raised from the build surface.

1. A method of 3D printing a part using a photopolymer build material, the method comprising the steps of:
a) characterizing a three-dimensional curved surface using a mathematical equation and a specification;
b) characterizing at least one surface transition between at least two parallel slice planes that intersect said characterized three-dimensional curved surface using a surface transition equation;
c) generating at least one set of 3D printing instructions to selectively solidify said photopolymer build material using:
i) at least one solidification region defined on at least one slice plane that intersects said characterized three-dimensional curved surface;
ii) said surface transition equation; and
iii) a photopolymer-specific relationship between an actinic exposure and a photopolymer solidification thickness; and
d) 3D printing said part using said at least one set of 3D printing instructions.

2. The method of claim 1, wherein the step of using a mathematical equation comprises using at least one of:
an analytic equation that is continuous over a real domain of a three-dimensional curved surface;
a piecewise-defined equation that comprises at least two analytic sub-functions and is piecewise continuous over a real domain of a three-dimensional curved surface;
at least one plane curve that is continuous or piecewise-continuous and describes said three-dimensional curved surface when extended into three-dimensional space; and
a conic section.

3. The method of claim 1, wherein the step of using said specification comprises using at least one of:
a conic section eccentricity;
a conic section focus;
a conic section directrix;
a conic section axis;
a conic section vertex;
a weighted control point; and
a domain that defines a spatial extent of a plane curve in at least one dimension that extends to a spatial extent of said three-dimensional curved surface.

4. The method of claim 1, wherein the step of using said specification comprises using at least one of:
a mathematical equation type, a mathematical equation form, and a generating function;
a coefficient of at least one term in a mathematical equation;
at least one term to evaluate a power series representation of a mathematical equation;
an angle of rotation of said curved surface;
a translation of said curved surface;
a normal vector at a point on said curved surface;
a domain that defines a spatial extent of said curved surface in at least one dimension of real three-dimensional space;
a piecewise sub-function used to at least partially characterize said curved surface;
an interval that defines a piecewise sub-function used to at least partially characterize said curved surface; and
a computer aided design file, a point-cloud file or a table of coordinate points that permits a characterization of said curved surface using a known or approximative mathematical equation.

5. The method of claim 1, wherein the step of using said specification further comprises using at least one boundary condition to define said at least one solidification region, the at least one boundary condition comprising at least one of:
a direction;
a coordinate point;
a vector;
an axis;
a boundary surface; and
a boundary plane curve used to characterize a boundary surface.

6. The method of claim 1, wherein at least one of said mathematical equation and said specification is transmitted electronically using at least one of:
a software application;
a plugin to a software application;
a website;
electronic mail;
a web application; and
a plugin to a web application.

7. The method of claim 6, wherein at least one of said mathematical equation and at least one element of said specification is automatically reviewed by evaluating at least one of:
a surface curvature that comprises said curved surface;
a surface area that comprises said curved surface;
a spatial extent of said curved surface in real three-dimensional space;
a solidification region of a part volume that comprises said curved surface;
a presence of a discontinuity within a domain of said curved surface; and
a boundary condition of a part volume that comprises said curved surface.

8. The method of claim 7, wherein at least one of said mathematical equation and said specification is automatically processed to provide at least one of:
a price estimate for 3D printing a part comprising said specified three-dimensional curved surface;
a price estimate for producing a molded part from at least one 3D printed part mold that comprises said specified three-dimensional curved surface;
a manufacturing time estimate;
a visualization of said specified three-dimensional curved surface; and
a visualization of a part volume comprising said specified three-dimensional curved surface.

9. The method of claim 1, wherein said surface transition equation is determined using at least one of:
said mathematical equation;
said specification;
an approximative equation used to approximate said specified three-dimensional curved surface over an interval bounded by said at least two parallel slice planes;
a cross section of a tessellated part volume that comprises said specified three-dimensional curved surface;
at least one derivative or partial derivative computed from a point located on a cross section of said specified three-dimensional curved surface; and
at least one gradient computed from at least one point located on or between said at least two parallel slice planes.

10. The method of claim 1, wherein a distance between said at least two parallel cross sectional slice planes is at least one of:
fixed;
variable; and
adaptive.

11. The method of claim 1, wherein said at least one solidification region is located between a plane curve found from the intersection of said specified three-dimensional curved surface with a slice plane and at least one of:
a second plane curve computed from the intersection of a slice plane with at least one additional continuous or piecewise continuous surface;
a second plane curve computed from the intersection of a slice plane with a boundary surface;
a second continuous or piecewise continuous boundary plane curve;
a boundary interval; and
a boundary determined by slicing a tessellated part file.

12. The method of claim 1, wherein the step of generating said at least one set of 3D printing instructions to selectively solidify said photopolymer build material comprises at least one of:
generating a two-dimensional illumination mask image with at least one grayscale pixel value;
generating a temporal mask illumination intensity function;
generating a mask image display time;
generating a spatial-temporal laser beam deflection path; and
generating a spatial-temporal laser intensity function.

13. The method of claim 1, wherein the step of generating said at least one set of 3D printing instructions is performed after solidifying at least one portion of said photopolymer build material.

14. The method of claim 1, wherein said at least one set of 3D printing instructions is generated or modified in response to a measurement of at least one of:
a solidified part geometry;
a portion of an actinic exposure that is delivered to at least one portion of a build material over a specified time interval;
a mask illumination source intensity;
an optical phase delay provided by a spatial light modulator;
a photopolymer temperature;
an illumination source temperature;
a laser source intensity;
a laser beam deflection path; and
a position signal provided by a beam steering, beam displacement or beam scanning component.

15. The method of claim 1, wherein said at least one set of 3D printing instructions is interpreted by a hardware controller that controls an operating condition of at least one of:
an illumination source;
an optical modulator;
an optical shutter;
a liquid crystal filter;
a beam steering, beam displacement, or beam scanning component;
a temperature controller;
a photopolymer wiper blade;
a camera;
a piezoelectric or MEMS actuator;
a stepper or servo motor; and
a spatial light modulator.

16. The method of claim 1, further comprising a processing step, the processing step being selected from at least one of:
polishing said 3D printed part;
applying a coating to said 3D printed part; and
post-curing said 3D printed part.

17. A method of fabricating a molded part from at least one 3D printed part produced according to claim 1, said method of fabrication comprising at least one of the following steps:
casting;
compression molding;
injection molding;
glass replication; and
precision glass molding.

18. The method of claim 17, further comprising the step of coating said molded part.

19. The method of claim 17, further comprising an overmolding step in which additional material is added to said molded part using at least one additional mold part, said overmolding step comprising at least one of the following steps:
casting; and
injection molding.
